(19) United States
(12) Patent Application Publication
(10) Pub. No.: US 2004/0176246 A1
(43) Pub. Date: Sep. 9, 2004

(54) Catalyzing filters and methods of making

(75) Inventors: Ryan C. Shirk, Mendota Heights, MN (US); Thomas E. Wood, Stillwater, MN (US); Yuji Ishikami, Yokohama (JP)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/382,039

(22) Filed: Mar. 5, 2003

(51) Int. Cl. B01J 23/02

(52) U.S. Cl. 502/439

(57) ABSTRACT

Catalyzing filters and methods for placing catalyst onto filter media, which involve positioning the catalyst at locations on the filter media where materials to be catalyzed will make contact during the filtering process.

### FIELD OF THE INVENTION

This invention relates to filters, in particular, to filters for engine exhausts and, more particularly, to filters for engine exhausts that include a catalyst, i.e., “catalyzing filters”. The invention also relates to methods of preparing catalyzing filters and catalyst systems useful with such filters. While this disclosure discusses the invention in the context of diesel engine exhaust filters, the invention is not intended to be so limited.

### BACKGROUND

Commercial and industrial uses of filters that include a catalyst component are generally well known. Many examples of such applications and such filters exist, with a single example being the use of catalyst-containing filters to remove or react materials (e.g., particulates and gaseous chemical compounds) from diesel fuel exhaust streams.

Diesel engines typically emit a sooty or otherwise noxious exhaust that can be cleaned by using a filtering system to remove undesirable matter (e.g., soot particles) from the exhaust. Such filters trap soot particles exhausted by an engine and thereby prevent the particles from entering the atmosphere. The soot trapped by such filters builds up over time, causing an increased exhaust gas back-pressure that decreases engine performance. A filter that contains an accumulation of particulate matter must periodically be either replaced or regenerated. Many such filters quickly clog, e.g., in as little as 200 kilometers of driving, in the case of diesel passenger cars, so replacement of clogged filters for general use is not practical. Periodic regeneration of the filter (i.e., removal of the trapped soot without removal of the filter) is a preferred method of maintaining a clean filter.

There are several techniques known for regenerating catalyzing filters. One technique involves raising the temperature of the exhaust gas to periodically burn soot trapped in the filter media. This can be accomplished through the introduction of additional fuel e.g., with a gas burner immediately upstream of the filter. Other techniques involve the use of catalytic materials coated on the filter media. Still other techniques involve fuel having catalytic additives that lower the oxidation temperature of the soot. Finally, some techniques use electrical heating elements in contact with filtering media. See e.g., U.S. Pat. No. 5,258,164 (Bloom et al.), U.S. Pat. No. 5,049,669 (Smith et al.), and U.S. Pat. No. 5,224,973 (Hoppenstedt), European Pat. Appl. No. 0 543 075 A1. These different techniques can also be used in combination.

U.S. Pat. Nos. 4,966,873, 5,320,998, and 5,610,117 describe different types of chemical catalyst systems and different filter media. The filter medium can comprise, for example, a ceramic material such as an extruded ceramic or a ceramic foam; a natural or synthetic fiber wound onto a core; a non-woven material; paper or other non-woven materials such as in a pleated paper filter; or other materials. A catalyst is also incorporated into the filter. When the filter becomes loaded with particulate matter, the filter is regenerated by reacting the particulate matter with an oxidizing agent such as oxygen in the exhaust stream, in the presence of a catalyst to break down the particulate matter. A heating component such as an electric or other type of heater can be used to heat the filter, particulate matter, and catalyst, to facilitate reaction.

There is opportunity for improvement in finding methods that provide useful or improved application of catalyst to filter media. There is also opportunity for new and useful filter media.

### SUMMARY OF THE INVENTION

The present invention is directed to the manufacture of catalyzing filter media, the resulting catalyzed filter media and catalyst systems used to make such media. The method of manufacturing a catalyzing filter medium, according to the present invention includes applying or depositing catalyst material onto selected surfaces of a filter medium such as, for example, a filter medium used in an exhaust system of an internal combustion engine. As used herein, a filter medium is defined as a porous medium or body designed to allow, or capable of allowing, a gaseous medium to flow into the porous body through one or more inlet surfaces and out of the porous body through one or more outlet surfaces. In addition, the term “porous medium” refers to a medium that is sufficiently porous to allow a gas to flow therethrough. In at least its final form, the filter medium allows a filtered material, with the gaseous medium, to enter into the porous body through one or more inlet surfaces but prevents all or at least a portion of the filtered material from exiting the porous body through one or more outlet surfaces, with the gaseous medium. As used herein, a filtered material is a material to be filtered from the gaseous medium by the filter medium (e.g., a catalyst system). In one embodiment, the filter medium has a design and composition suitable for use (i.e., is operatively adapted so that it can survive) in an engine exhaust. Such filter media usually comprise inorganic materials such as, for example, ceramic materials including refractory ceramic materials.

In addition to being used with a filter medium, it is contemplated that the present invention can be directed to various porous media and methods of applying or depositing catalyst material onto selected surfaces of a porous medium such as, for example, a porous medium used as a catalytic element for a catalytic converter in an exhaust system of an internal combustion engine. It is also contemplated that the present invention can apply to a porous medium that could be used as a filter medium but is actually used only as a catalytic element. Therefore, it is contemplated that some, most or all of the disclosure herein relative to a filter medium may be applicable to a sufficiently porous medium as well. The present invention is also directed to catalyst systems that include at least the catalyst material and optionally an adhesive component. The catalyst systems of the present invention preferably comprise carrier liquid and catalyst material, with or without an adhesive component. The catalyst material in such a catalyst system may comprise catalyst material-containing liquid droplets or wet catalyst material particles. As used herein, the term “catalyst material” refers to catalysts, as well as catalyst precursors that will form catalysts, and combinations thereof. The catalyst material may be in a solid or dissolved form. Either or both of the adhesive component(s) and the catalyst precursor(s) may be dissolved in the carrier liquid. Specific problems with prior techniques for applying catalyst material onto filter media have been identified.

For a catalyzing filter to perform in reacting with (e.g., oxidizing or degrading) particulate exhaust matter (e.g., soot particles) or other exhausted matter (e.g., NOₓ gas) flowing into the filter, the exhaust matter must contact the catalyst in the filter medium, not just the filter medium. The exhaust matter is normally trapped, deposited or makes contact only at certain locations on or within the filter medium, based on the flow of the exhaust through the filter medium and the structure of the filter and filter medium. On a relatively large scale, particulate matter will be trapped and accumulate at different portions or regions of a filter, such as at or near an inlet surface. This general distribution (or concentration profile) of accumulation of particles differs for different filter media and particle systems. Looking at a smaller scale, at small surfaces of a filter medium, e.g., in the size frame of particulate matter that will flow into the filter medium and the size of structures of a filter medium, the nature of the flow of the particulate matter into and through the filter medium will cause the particulate matter to come into contact with certain surfaces of the structure of a filter medium, but not others. Catalyst material placed on filter media at locations that will not come into contact with the material to be catalyzed, e.g., where particulate matter does not become trapped or deposited during use, can be wasted, because such catalyst material generally will not contact particulate matter and therefore will not perform the intended function of catalyzing a reaction.

Thus, certain portions of a filter medium will accumulate and/or be contacted by particulate exhaust matter during use, be contacted by gaseous exhaust matter (e.g., NOₓ, etc.), or both. Certain surfaces of the filter medium will be directly contacted by exhaust matter (e.g., trap particulate matter) during use. To be effective in catalyzing a reaction with the exhaust matter (e.g., particulate matter, NOₓ, etc.), the catalyst material must be located at portions of a filter medium that accumulate or are contacted by exhaust matter (e.g., particulate matter, NOₓ, etc.) to be catalyzed. Within those portions, catalyst should be located at the particular surface that will contact, e.g., trap, the matter to be catalyzed. Catalyst that is located on other portions or surfaces of a filter medium, which will not be in the path of the exhaust matter, is not placed to act as a catalyst and is wasted.

When catalyst is applied to a filter medium by saturation wetting (e.g., by dipping or spraying), the exterior surface portion generally is indiscriminately coated with catalyst, or catalyst is caused to saturate a filter medium, which also indiscriminately coats the different structural surfaces of the filter medium with a substantially uniform concentration of catalyst deposited over any structural surfaces of the filter medium to which the coating is applied. This can be true whether catalyst is sprayed only onto an outer face of a filter medium, or if a filter medium is dipped into a catalyst solution that saturates the filter medium. For the portions of the filter medium that have catalyst coated onto them—meaning substantially all portions of the filter medium (e.g., if dipped and saturated) or only a fraction or fractions of all portions of the filter medium (e.g., an outer portion if sprayed or dipped and not saturated)—the catalyst can dry to produce a substantially uniform concentration of catalyst at structural surface locations of the filter medium. By such non-selective methods of catalyst application, filter surfaces that during use will not be contacted by exhaust matter flowing into the filter medium can have an applied concentration of catalyst that is similar to the concentration of catalyst at filter locations that will be contacted by exhaust matter during use. These non-selective catalyst placement techniques can therefore be wasteful. In addition, by saturation wetting, it may not be efficient to use very fine catalyst particles in cases such as diesel soot oxidation where it is desired that the highest oxidation activity be on surfaces where the diesel soot collects. This is because the fine catalyst particles may migrate into the filter medium and become lodged in pores and areas of the filter where diesel soot will not collect.

Separate but related problems occur that are specific to particular filter media such as fiber wound filter media, ceramic fiber-based paper filter media, etc.. For example, fiber wound filter media are typically prepared by, preferably, texturizing a continuous fiber, e.g., in the form of a yarn, followed by winding the fiber yarn onto a supporting tube. When texturing is used in such a process, a significant amount of fiber “fuzz” can be generated at exterior or “outer” portions of the filter medium. This “fuzz” can trap particulate matter during use of the filter media. But, when the fiber wound filter is dipped into, or otherwise saturated with, a catalyst solution to apply a catalyst material, a higher concentration of catalyst solution penetrates the fiber yarn and only a relatively lower concentration of catalyst material is deposited onto the outer “fuzz” portion, where catalyst can most effectively contact exhaust matter (e.g., particulate matter).

Embodiments of methods of the present invention can be improvements over known catalytic filter manufacturing techniques by applying catalyst material in a manner that places catalyst mostly or only on useful surfaces of a filter medium where exhaust matter (e.g., particulate matter, NOₓ, etc.) will accumulate during use, at or near positions of the filter medium where exhaust matter will contact, e.g., become trapped or deposited, or both. In this context, the terms “position” and “surface” of a filter medium means a structural surface such as a surface of a fiber, foam or ceramic structure, paper fiber, etc.. This means that less catalyst overall needs to be placed on the filter medium, with a lower amount of catalyst being placed at positions of the filter medium where exhaust matter will not be trapped, deposited or otherwise make contact, i.e., is wasted. The result is a filter that can have the same or similar effectiveness in removing and catalyzing exhaust matter such as, e.g., during regeneration, while reducing the overall amount of catalyst required for effective catalytic function.

In an exemplary embodiment of a method of the invention, catalyst material is deposited onto a filter medium by suspending, dispersing or otherwise placing the catalyst material in a gas (e.g., air, an inert gas, or any other suitable gaseous medium) so as to form a gaseous catalyst dispersion. A gaseous catalyst dispersion comprises a catalyst material that is generally or uniformily dispersed or otherwise contained in a gaseous medium (e.g., particles of catalyst material suspended in the gaseous medium). The gaseous catalyst dispersion is flowed into the filter medium such that the gaseous medium flows through the filter medium and at least some or all of the catalyst material and liquid deposits on surfaces of the filter medium. The catalyst material can be deposited so that the catalyst is permanently adhered to inlet surfaces, outlet surfaces, interior surfaces or a combination of the surfaces of the filter medium. The catalyst can be the type that remains active, or can be reactivated, for extended periods of use. The catalyst material in the gas is coated by a liquid, carried by a liquid or both. For example, the catalyst material included in the gas flowing through the filter medium (a) can be dissolved in liquid droplets, (b) can be in the form of solid particulate suspended, dispersed or otherwise located in liquid droplets, (c) can be in the form of solid particulate partially or completely coated with a liquid (i.e., wet), (d) can be agglomerates of solid particulate partially or completely coated with a liquid (i.e., wet), or (e) can be a combination thereof. The liquid can be in any form (e.g., droplets) capable of being carried along by the flow of gas and trapped or otherwise deposited in the filter medium, with the catalyst material being in or carried by the liquid.

The catalyst system can comprise carrier liquid and catalyst material, with or without an adhesive component. The catalyst system in the gas flowing through the filter medium contacts surfaces of the filter medium and adheres to, becomes trapped by or are otherwise deposited on, at least some, most or all of those surfaces contacted in the filter. This gas flow can be made similar to, or even identical to, the exhaust flow conditions associated with the filter during use, in an effort to cause the catalyst material to become trapped or otherwise deposited in the filter medium at locations where exhaust matter (e.g., particulate matter, NOₓ, etc.) would also accumulate and/or make contact during use. Filter medium containing deposited catalyst material can then be calcined, fired or both calcined and fired to permanently adhere the catalyst to the filter medium.

According to other embodiments of methods of the invention for manufacturing a catalyzing filter medium, catalyst material can be included in the flow of gas by being carried by (e.g., dissolved, suspended, dispersed or otherwise contained in) one or more liquid droplets. These catalyst material containing liquid droplets are in turn contained in or carried by a gas that is flowed through the filter medium. It can be desirable to heat the filter medium, the gaseous medium, the catalyst material, the liquid or a combination thereof before, during or after the gaseous catalyst dispersion is flowed into the filter medium. This heating can be sufficient to cause a reaction that results in catalyst material, deposited on surfaces of the filter medium, to permanently adhere to at least some, most or all of the desired interior and/or exterior surfaces of the filter medium. In one particular embodiment, the liquid can optionally be at least partially dried (e.g., by heating, reducing the humidity of the surrounding gas, etc.) prior to, during, or soon after being deposited onto surfaces of the filter medium. This drying reduces the amount of the liquid, or removes the liquid, which can improve placement of the catalyst on the filter medium by preventing or at least significantly reducing mobility of the catalyst material after it is deposited. Droplets of the carrier liquid deposited at desired locations within a filter medium can be quickly dried so that the catalyst therein becomes secured at or near the location where the catalyst material initially made contact or is deposited, and does not have an opportunity, prior to drying, to move or migrate to a different location on the filter where the catalyst may be less effective based on a reduced likelihood that the catalyst will be contacted by exhaust matter (e.g., particulate matter, NOₓ, etc.) during use. Optionally, the catalyst system can include an adhesive component to facilitate the anchoring of the catalyst material substantially at or near the position at which the catalyst material initially contacts surfaces in the filter medium. The adhesive component may be chosen so as to include catalytic characteristics. In addition, the catalyst material may also be chosen so as to include adhesive properties.

The placement of a catalyst in a filter medium can be affected by the properties of the liquid droplet containing the catalyst material. Such properties can include the liquid content (i.e., solids to liquid ratio) of the droplet, the size of the droplet, the density of the droplet, and the tendency of the droplet to stick when it hits (i.e., its adhesiveness). In general, for example, it has been found that larger droplets tend not to go as deep into a given filter medium as smaller droplets, while finer droplet sizes tend to penetrate deeper into the filter medium. Therefore, a particular catalyst material may be placed deeper or shallower into a filter medium by controlling the droplet size. The droplet sizes that can be used include droplets having a diameter of less than about 15 microns, less than about 10 microns, less than about 5 microns or less than about 2 microns. In addition, dryer droplets (i.e., droplets having a higher solids to liquid ratio) are less likely to stick upon first contact with a surface of the filter medium, or even after multiple contacts. Thus, drying the droplets (i.e., reducing its liquid content) can enable the droplet to bounce from surface to surface and travel deeper into the filter medium before sticking.

Also contemplated to be within the invention is the placement of a catalyst in a filter medium by mechanically trapping a solid catalyst material particle in the filter medium. This placement mechanism (i.e., mechanical trapping) relies more on the affect that the size and shape of catalyst material particles have on being trapped by the filter, and less on the adhesiveness of the catalyst material particle to the filter medium. This placement mechanism can be used by itself or in combination with other catalyst placement mechanisms described above (e.g., an adhesion mechanism).

A catalyst system according to the present invention can comprise one or more catalyst materials in a carrier liquid. The catalyst material can be chosen to be any type or chemistry that results in a catalyst suitable for the particular application. The catalyst can be the type that remains active, or can be reactivated, for extended periods of use. In certain embodiments, the catalyst system can include an adhesive component that is effective in adhering the catalyst material to the filter medium. The adhesive component may or may not exhibit catalytic characteristics. When the adhesive component functions predominantly as a catalyst, it can be seen as an adherent catalyst material.

The carrier liquid can be in the form of droplets suitable for being suspended or otherwise placed in a gas (e.g., air, an inert gas, or other suitable gaseous medium) and carried along by the gas when the gas is flowed through the filter medium so that the droplets are trapped or otherwise deposited in the filter medium. The catalyst material, the adhesive component, or both can be (a) dissolved in the liquid droplets, (b) in the form of solid particulate suspended or otherwise dispersed in the liquid droplets, (c) in the form of solid particulate coated with the liquid, (d) agglomerates of solid particulate coated with the liquid, or (e) a combination thereof.

The liquid tends to cause an initial adherence or positioning (i.e., wet-out) of the catalyst material-containing droplet on a surface of the filter medium after making contact with one or more such surfaces. The liquid droplets can be charged so as to be electrostatically attracted to the filter medium. The adhesive component can adsorb onto the filter medium upon contact of the liquid droplet and the filter medium, thereby increasing the adhesion of the liquid droplet to the filter medium. In addition, or alternatively, one or more adhesive components can be chosen so that, after drying, calcining, firing or a combination thereof, the catalyst material is bonded in place and does not move or migrate through the filter medium. The chemistry of the adhesive component can be chosen so as to have a strong affinity to the chemistry of the filter medium and the catalyst, and thereby adhere the catalyst better to the filter medium.

In accordance with the present invention, a catalyst is more likely to be applied or placed at locations on a filter medium where, during use, exhaust matter (e.g., particulate matter, NOₓ , etc.) will become trapped or deposited or otherwise make contact with the catalyst. At the same time, the catalyst is less likely to be applied or placed at locations on the filter medium where exhaust matter will not become trapped or deposited or otherwise make contact with the catalyst. Therefore, a higher concentration of catalyst will be at locations on the filter medium where, during use, exhaust matter will become trapped or deposited or otherwise make contact with the catalyst, and a relatively lower concentration or none of the catalyst will be at locations on the filter medium where, during use, exhaust matter will not become trapped or deposited or otherwise make contact with the catalyst. In this way, the catalyst, which is generally an expensive component of a catalyzing filter, is deposited more cost effectively, with less catalyst wasted. The resulting filter medium can have varying concentrations of catalyst therethrough, with a relatively high concentration of catalyst at locations of the filter medium where, during use, exhaust matter is more likely to make contact and a relatively low or no concentration of catalyst at locations of the filter medium where, during use, exhaust matter is less likely to make contact. In this way, the catalyst can also be distributed through part, or all, of the filter medium according to a desired concentration gradient. For example, there can be a higher concentration of the catalyst at the surface(s) through which exhaust gases enter into the filter medium and a lower concentration of the catalyst, or no catalyst, at the surface(s) through which exhaust gases exit the filter medium.

In standard catalyst application methods of saturation wetting, large amounts of catalyst are applied to fiber-based filters (e.g., inorganic fiber wound filters, ceramic fiber-based paper filters, etc.) to ensure that catalyst is retained on active portions of the filters. In addition to the cost of the extra catalyst, this excessive coating can cause embrittlement of the fibers. However, with the present invention, a percentage or portion of the fiber surface can be covered by a catalyst such that enough of the fiber surface is left without a catalyst that the fiber body can retain its flexibility. In other words, the present invention can enable the catalyst to be distributed along the fiber length as discrete areas and not a continuous coating. For example, the surface of the fiber can be dotted with the catalyst material.

By allowing the use of less catalyst material and less adhesive components to achieve effective catalytic activity, the present invention can provide a filter with higher filtration capacity, because the catalyst material and adhesive components used occupy void space in the filter. This reduction of open area in the filter by introduction of such materials reduces the capacity of the filter and undesirably increases the back pressure of the filter. The reduced amount of catalyst and other catalyst system components (e.g., adhesive components) placed on a filter by use of the present invention results in increased void space and increased filtration capacity.

Furthermore, in embodiments of filters that include a regeneration mechanism (e.g., a heater element integrated into a filter medium), the concentration of catalyst located on the filter so as to optimize the regeneration capability (e.g., located at or near the heater element) can be increased using the methods of the present invention. In this way, the present invention can, for example, allow for better heat transfer between the heater element and the catalyst, thereby lowering the needed energy for regeneration.

The invention contemplates filter media and filters that include catalyst preferentially positioned at locations on a filter medium where the catalyst will be contacted by exhaust matter flowing into the filter medium. For example, catalyst can be located and concentrated at those portions of a filter medium where particulate matter will accumulate during use. Less catalyst (i.e., lower amounts and concentrations of catalyst) can be located at portions of the filter medium that will have less particle accumulation or concentration. On a smaller scale, preferably within the portions of a filter medium where particulate matter will accumulate, the filters have catalyst located and concentrated at surfaces of the filter medium that contact particulate matter, and lower concentrations of catalyst or no catalyst at those surfaces that do not contact particulate matter. Embodiments of filters prepared according to the invention can exhibit equivalent or preferably improved performance relative to filters made by other techniques such as those involving saturation wetting, even as the invention also allows a reduced overall amount of catalyst to be placed on the filter.

The filter media can optionally include different regions or portions of their cross sectional thickness, which have different catalysts or different concentrations of the same or different catalysts. Different catalysts can be selected to react with different particulate or gaseous matter. The different catalysts can be located on the filter medium at the different positions of the filter medium, e.g., thickness range, where the different reactions occur. For instance, two different catalysts can be included in a filter medium, with one catalyst effective to catalyze reaction of a first exhaust matter to produce a reaction product, and the second catalyst effective to catalyze reaction of the reaction product to still another reaction product. Alternatively, different catalysts can be located at different portions of a filter medium based on the size of the exhaust matter that the catalyst is effective in catalyzing. For example, a catalyst that catalyzes a relatively large reactant that will be trapped at or near a surface of a filter medium can be located at or near that surface of the filter medium. In addition, a catalyst that catalyzes a relatively smaller reactant, which will flow deeper into the filter medium, can be located at such a deeper location within the filter medium. The method of the present invention enables such a selective placement of active catalysts regardless of size, even in cases where the catalyst particles are essentially the same size and are very small.

The present invention also contemplates filter media that exhibit a concentration gradient of one or more catalyst across one or more portions of a thickness of a filter medium, especially in a manner that reflects a concentration profile of exhaust matter (e.g., particulate matter) accumulation during use. A filter medium of the invention can have a high concentration of catalyst at one surface and a lower concentration of catalyst at a different location across the thickness of the filter, such as at an internal location or such as at another surface of the filter medium. In this context, the “surface” of a filter refers to an exterior surface area of a filter medium. For example, the first surface can be an inlet surface where a flow of gas and/or particles enter the filter medium and the other surface can be an exit surface where a flow of gas and/or particles exits the filter medium. More specifically, a filter can have a high concentration of a catalyst at an inlet surface of the filter medium, and the concentration can gradually and continuously decrease (e.g., linearly or otherwise) in the direction of flow through the thickness of the filter medium (or, in the direction opposite of the flow of gas during use). For example, a lower concentration of catalyst can be present at the interior of the filter medium, and an even lower concentration can be present at the exit surface of the filter medium. Alternatively, an initial concentration can be present at the inlet surface of the filter medium, and that concentration can reduce to zero at an internal point of the filter medium; the concentration at the exit surface can also be zero. The present invention enables such a gradient to be achieved even in the case where all the catalyst particles are of very small size. This concentration gradient, e.g., of very fine particles, is believed to differ from concentration profiles of similarly sized catalysts applied by saturation methods, because, in general, saturation methods place similar concentrations of catalyst on both sides of a filter medium and the smaller particles penetrate the filter medium whereas only the larger particles are retained on the surface of the filter media. Thus, saturation methods often undesirably result in the finest and most active high surface area catalyst particles being buried in the filter medium and the larger less active catalyst particles being present on the surface of the filtration medium.

An aspect of the invention relates to a method of manufacturing a filter medium. The method comprises depositing catalyst on a filter medium by including a catalyst material in a gas flowing through the filter medium so that catalyst material contained in the gas flowing through the filter medium becomes trapped or otherwise deposited on the filter medium.

Another aspect of the invention relates to a method for applying catalyst to a filter medium. The method comprises causing liquid droplets carrying a catalyst material to flow into the filter medium where the droplets contact one or more surfaces of the filter medium and adhere to one or more of the filter medium surfaces proximal to the point of contact.

A further aspect of the invention relates to a method of applying catalyst to a filter medium. The method comprises providing a filter medium, determining a particle concentration profile of particles (e.g., soot) deposited onto the filter medium during use, and applying catalyst material to the filter medium to result in a catalyst concentration profile that reflects the particle concentration profile. The catalyst material can be particles of a size that is the same as or that is different than the size of the particles being deposited onto the filter medium during use.

Yet another aspect of the invention relates to a filter medium comprising catalyst for catalyzing reaction of exhaust matter flowing into the filter. The filter medium having a thickness with a first catalyst material at one position along the thickness and a second catalyst material at a second position along the thickness. Positions of the first and second catalyst along the thickness are selected to correspond to locations where exhaust matter to be catalyzed will be located in the filter medium during use.

Still another aspect of the invention relates to a filter medium comprising catalyst for catalyzing a reaction of exhaust matter flowing into the filter medium, wherein the concentration profile of catalyst across a thickness of the filter medium reflects a concentration profile of particles of exhaust matter to be catalyzed that occurs when the particles become deposited on or trapped by the filter medium during use of the filter medium.

Another aspect of the invention relates to a catalyzing filter medium suitable for use in an engine exhaust. The filter medium comprises a porous body suitable for use in an engine exhaust, catalyst material concentrated at locations in the porous body where material to be catalyzed flowing into the filter medium will contact the catalyst material. The filter medium comprises a lower concentration of the catalyst material at locations in the filter medium where the material to be catalyzed, flowing into the filter medium, will not contact the porous body.

Another aspect of the present invention relates to a catalyzing filter medium suitable for use in an engine exhaust, where the filter medium has a thickness and comprises a catalyst material for catalyzing a reaction of exhaust particles flowing into the filter medium. The filter medium has a concentration profile of the catalyst material across the thickness that reflects a concentration profile of exhaust particles that occurs when the exhaust particles become deposited in the filter medium during use of the filter medium in an engine exhaust.

Still another aspect of the invention relates to a filter medium having a concentration of catalyst at an inlet surface of the filter medium, a lower concentration of the catalyst at an interior location of the filter medium, and an even lower concentration of the catalyst (which may be zero) at an outlet or exit surface of the filter medium. The concentration can decrease gradually and continuously along the direction of flow through the filter medium even in the case where the catalyst material is particles that are very small. Particles having a major dimension that is less than 100 nanometers, or even 50 nanometers, can be distributed in this way. This profile distinguishes over profiles attained by applying a catalyst by saturation wetting for such small particle catalyst systems because saturation wetting techniques place catalyst material at both the inlet and the outlet surfaces, in similar concentrations and because with saturation techniques, particles penetrate the surface of the filter medium and are separated in the medium according to the size of the particle, with small particles generally penetrating the media and only the larger particles remaining on the surface of the media.

Another aspect of the invention relates to an apparatus for manufacturing a filter by depositing catalyst onto a filter medium. The apparatus comprises: a gas-flow-generating component for generating a flow of gas, an adapter component for positioning a filter medium in the flow of gas, a catalyst material introduction component for introducing catalyst material into the flow of gas before the gas contacts the filter medium.

Another aspect of the invention relates to a catalyst system comprising carrier liquid droplets carrying a catalyst material, the liquid effectively causing the droplets to initially adhere to, or wet-out on, surfaces of a filter medium while the droplets are dispersed in a gas flowing through the filter medium.

“drying” refers to removal of greater than 90 percent by weight of the carrier liquid, including solvents (e.g., water);

“calcining” refers to heating to at least a temperature at which: any remaining volatiles (including all organic materials and water) that were present in a dried substrate are removed, accompanied by the transformation of any ceramic precursor materials that may be present into metal oxide(s); and

“firing” refers to heating to at least a temperature at which chemical bonds form between contacting ceramic particles of a calcined substrate, typically resulting in increased strength and density.

Calcining and firing can be made to occur sequentially or at about the same time, depending on the temperature and time at temperature for the calcining and firing. For example, a separate calcining may be avoided by firing the filter medium directly after the catalyst material is applied or after the catalyst material containing filter medium is dried. Calcining and/or firing can be carried out in the presence of a reducing agent (e.g., a gas) to promote the formation of a reduced phase catalyst (e.g., a metal catalyst).

### BRIEF DESCRIPTION OF THE DRAWINGS

FIG. 1 illustrates an embodiment of a method of preparing an exemplary filter medium according to the present invention.

FIG. 2 illustrates another embodiment of a method of preparing an exemplary filter medium according to the present invention.

FIG. 3 is a sectional view of an exemplary filter media prepared according to one embodiment of the present invention.

FIG. 4 is a sectional view of an exemplary filter media prepared according to another embodiment of the present invention.

FIG. 5 is a sectional view of an exemplary filter media prepared according to a further embodiment of the present invention.

FIG. 6 illustrates a catalyst material concentration profile across the thickness of an exemplary filter medium, in the direction of gas flow, according to an embodiment of the present invention.

FIG. 7 illustrates a catalyst material concentration profile across the thickness of an exemplary filter medium, in the direction of gas flow, according to another embodiment of the present invention.

### DETAILED DESCRIPTION

The invention relates to methods of manufacturing filters, filter media, filter cartridges, other filtering products, etc., by depositing catalyst onto a filter medium; catalyst components with gradations of adhesiveness for adhering to a filter medium upon contact, and which includes a carrier liquid and can include an adhesive component; and also relates to filter media, filter cartridges, filters, and other filtering products.

According to a method of the invention, catalyst material is included in a flow of gaseous medium directed through a filter medium. As the gas flows through the filter medium, catalyst material contained in and carried by the flowing gas becomes deposited onto or in the filter medium, e.g., on a surface (meaning a structural surface of the filter medium such as a fiber, strand, etc.), crevice, intersection of surfaces (e.g., a site of overlapping fibers), or any other position of the filter medium. “Deposited” can mean stuck to a surface, trapped by the filter, or otherwise held back from the flow of gas through the filter medium. Advantageously, the catalyst material can be trapped or otherwise deposited at locations or surfaces on or within the filter medium where the catalyst will be efficiently used, e.g., where during use, matter to be catalyzed will contact the catalyst on the filter medium and allow a catalyzed reaction that involves the matter.

As opposed to methods of placing catalyst material on a filter medium by saturating, dipping, or spraying, methods described herein can be based on a pressure differential produced across a filter medium that causes a flow of catalyst material-containing gas through the filter medium in a way that causes the catalyst material to in effect be filtered and removed from the gas, while the gas that carries the catalyst material flows through the filter. The catalyst material-containing gas flows into the filter; catalyst material is removed from the gas by the filter and advantageously deposited on the filter medium at locations where the catalyst will contact other matter flowing through the filter while carried by a gas during use of the filter; and the filtered gas flows out of the filter, with catalyst material removed from the gas.

The pressure differential may be “positive” or “negative,” so that the flow of gas that carries the catalyst material can occur in either direction through the filter, based on preference or utility. For example, catalyst material may be deposited on one side, (i.e., portion or region), of the filter using a positive flow, meaning a flow in the direction that gas flows through the filter during use of the filter. A different concentration or type of catalyst material may be deposited on the opposite side of the filter using an opposite flow produced by a negative pressure.

The magnitude of the pressure differential can be chosen as desired to provide a useful result. Generally, a preferred pressure differential can be one that traps or deposits catalyst material in or on the filter medium at positions that are also positions where particulate matter will contact or become trapped or deposited during use. As an example of a general magnitude of pressure differential, the pressure differential may approximate the pressure differential that would be experienced by the filter during use of the filter. For diesel particulate filters, exemplary pressure differentials experienced during use can typically be approximately 20 kPa or less and up to a typical maximum of 40 kPa.

The gas used to carry the carrier liquid containing catalyst material into the filter medium can be any gaseous medium capable of so carrying the carrier liquid and catalyst material. Acceptable gases can include air, nitrogen, carbon dioxide, argon or mixtures of one or more thereof. If it is desired to use a reduction step to form a catalyst from a catalyst precursor, mixtures of hydrogen with an inert carrier gas or gases, such as argon or nitrogen, may be used.

The catalyst material may take any form, such as a dissolved liquid or a solid particle that can be dispersed, suspended, or otherwise contained in a liquid or a gas. Different variations of particulate and dissolvable (soluble) catalyst materials will be understood by the skilled artisan, as will the ability to apply those different variations of solid and liquid catalyst materials to filter products according to methods described herein.

In general, solid catalyst particles can be of any size that can be deposited onto a filter medium and that will thereafter usefully function to catalyze a reaction of material flowing through the filter medium. In general it can be desired that the catalyst particles be relatively small in size while retaining high catalytic activity. This is to provide as many active catalyst sites as possible per weight of catalyst so as to maximize the catalyst response and to minimize the required amount of expensive catalyst material. The size of a particular solid catalyst particle can depend on various factors such as the type of material being reacted (e.g., gaseous or solid), the chemistries of each of the catalyst material and the matter being reacted on the catalyst, and other variables related to the filter medium and its construction and intended use. Exemplary sizes of solid catalyst particles will be understood to those skilled in the catalyst and catalyst filter arts, with sizes sometimes being in the range from about 10 nm to about 20 micrometers, more generally in the range from about 20 nm to about 3 micrometers. In the case of relatively larger catalyst particles, such as particles in the micrometer range, the particles can be placed onto a filter medium by physical trapping in small pores or voids in the filter. In the case of relatively smaller catalyst particles, such as particles in the sub-micrometer range down into the nanoparticle range, the particles can be adhered to a filter medium, e.g., at a surface of the filter medium, by adsorption processes or by evaporative deposition during application of the catalyst material in the form of a dispersion of fine particles in liquid droplets (e.g., aerosol droplets), contained or suspended in a gaseous medium flowing through the filter medium. According to the adsorption technique the particles can be included in a liquid droplet, which can be made to adhere to the filter medium surface by passing the droplets through the filter. The droplets, on contact with the filter can be made to adhere to that location. It can be desirable for the liquid droplet carrying the catalyst material (e.g., small catalyst particles) to spread-out onto the surface of the filter medium. The spreading out of the liquid droplet causes the catalyst material (e.g., small catalyst particles) to be deposited onto a larger area of the filter medium surface. Such spreading-out of the liquid droplet onto the surface of the filter medium can be facilitated, for example, by the addition of a small amount of a surface active agent such as, for example, a wetting agent as is known in the coating art.

Wetting agents can include molecules, polymers and surfactants that lower the surface tension of the liquid droplet so as to facilitate spreading. Examples of suitable molecules can include alcohols and organic amines. Examples of suitable alcohols may include alcohols such as isopropyl alcohol, ethyl alcohol, tert-butyl alcohol, butyl alcohol, propyl alcohol, sec-butyl alcohol and other alcohols having at least moderate solubility in water. Examples of suitable organic amines may include nitrate and halide salts of quaternary organic amines having at least one organic moiety attached thereto, where the moiety comprises a carbon chain greater than two carbons in length. Water-soluble polymers and macromolecules such as, for example, those possessing hydroxyl groups, carboxylate groups, ethylene oxide or propylene oxide linkages, amido functionality, sulfonate groups, phosphate groups, amino functionality, or water soluble cyclic groups such as pyrroles may also be useful as wetting agents. Exemplary surfactants may include nonionic surfactants (e.g., sorbitan fatty acid esters, polyoxyethylene sorbitan fatty acid esters, and polyoxyethylene stearates) and anionic surfactants (e.g., dioctyl sodium sulfosuccinate, sodium lauryl sulfate, and sodium dodecylbenzenesulfonate). Commercially available surfactants include: nonionic surfactants, for example, those marketed by Uniqema (Bridgewater, N.J.) under the trade designations “SPAN”, “TWEEN”, and “MYRJ” and those marketed by BASF Corporation (Mount Olive, N.J.) under the trade designations “PLURONIC” and “TETRONIC”; and anionic surfactants, for example, those marketed by Stepan Company (Winnetka, Ill.) under the trade designation “POLYSTEP” and those marketed by Rhodia, Inc. (Cranbury, N.J.) under the trade designation “ALIPAL”.

The identity and concentration of the wetting agent typically depends on the nature of the catalyst materials used (i.e., catalyst particles, catalyst precursor particles, dissolved catalyst precursors, and mixtures thereof) and the desired catalyst properties. For example, a cationic wetting agent will tend to adsorb onto an anionic catalyst material, and an anionic wetting agent will tend to adsorb onto a cationic catalyst material. If such adsorption is allowed to occur, flocculation of the catalyst material can occur, resulting in a non-uniform dispersion of the catalyst and less catalyst surface area, which can lower catalytic activity. Therefore, in general, with a catalyst material comprising predominantly cationic catalyst materials, cationic wetting agents would be preferred over anionic wetting agents, and likewise, with a catalyst material comprising predominantly anionic catalyst materials, anionic wetting agents would be preferred. In addition, the use of small alcohol molecules such as, for example, ethanol, butanol or methanol as wetting agents can result in good spreading behavior for many catalyst systems, but in certain cases they can cause precipitation of the soluble catalyst precursors (e.g., when the soluble catalyst precursor material has a low solubility in the alcohol and too much alcohol is used), or flocculation of the catalyst particles and/or catalyst precursor particles (e.g., when the alcohol destabilizes an electrostatically stabilized catalyst dispersion).

Catalyst and catalyst precursor materials can be mono-phasic or multi-phasic depending on the desired catalytic properties. The catalyst particles and catalyst precursor particles can include particles with or without internal porosity. The catalyst particles and catalyst precursor particles can be processed and provided in desired sizes by methods that will be known and understood to the skilled artisan, for example by being ground into fine powers and filtered to size.

The amount of catalyst material, in dissolved or particle form, applied to a filter medium can be chosen as desired and can depend on well understood factors such as the type and chemistry of the catalyst material, its intended application (e.g., catalytic filters for cleaning diesel exhaust streams), the size of catalyst particles, the chosen filter medium, as well as other factors. The catalyst material can generally be any type of catalyst material that will be useful in applications involving a catalyst applied to a filter media. The catalyst chemistry can be selected based on factors relating to the intended use for the filter, the type of filter medium, etc. Any of a variety of different chemistries of catalyst useful in certain exhaust filtering applications may be useful with the catalyst systems, filters, filter media, and methods of the present invention.

One example of a catalyst system according to the present invention includes a carrier liquid and a soluble metal containing adhesive component, with a dispersed metal oxide catalyst and/or a dispersed metal oxide catalyst precursor. The liquid component can act generally as a carrier for solid catalyst or catalyst precursor particles, or for dissolved catalyst, dissolved catalyst precursor, or other dissolved species, and can be effective to cause the droplet or catalyst particle to initially adhere to the filter medium upon contact and optionally prevent, reduce, or minimize migration of the catalyst material after initial contact. The soluble metal containing adhesive component or species can be chosen so as to adhere catalyst material to a filter medium, may function as an active catalyst upon drying of the liquid, calcining and/or firing, or may function as both an adhesive component and a catalyst. As a proviso, at least one of the soluble metal containing adhesive component, the dispersed metal oxide and the dispersed metal oxide precursor functions as an active catalyst material.

The carrier liquid can be any liquid capable of carrying a catalyst, e.g., with the catalyst being dissolved, dispersed, suspended, or otherwise contained in the carrier liquid. Preferably, the liquid can also act to adhere the catalyst to a surface of the filter medium during application as described herein and prevent or minimize migration from that location. Exemplary liquids can include water or organic liquids such as toluene; alcohols such as isopropyl alcohol, methoxy-ethanol and the like; ketones such as methyl ethyl ketone; esters; and carboxylic acids. Important examples of carrier liquids include water and simple alcohols. The carrier liquid can optionally further contain additives for facilitating deposition of catalyst onto a filter medium. These may include wetting agents like that previously described.

The amount of a liquid solvent or carrier, or a liquid coating on a particle, relative to other components can be any useful amount to allow the liquid to perform as described. Depending on relative amounts of the liquid and catalyst, and the form of the catalyst (e.g., as particles), the catalyst can be dissolved, suspended, or otherwise contained within the liquid, or the liquid can be in the form of a coating on the surface of solid catalyst particles. Depending on the identity and form of the catalyst and the liquid, and other optional components, a very broad range of relative amounts within these general possibilities will be understood to be useful. The invention contemplates combinations of materials for application of catalysts, (e.g., “systems”), over a range of various different forms, including slightly wet particles, liquid droplets that contain solid catalyst materials (optionally with dissolved metal adhesive species), liquid droplets that contain solid catalyst materials and dissolved catalyst materials in similar amounts (optionally with dissolved metal adhesive species), liquid droplets that contain substantially more dissolved catalyst materials than solid catalyst materials (optionally with dissolved metal adhesive species), liquid droplets that contain dissolved catalyst materials (optionally with other dissolved metal adhesive species), different gradations of any of these, etc.

As discussed, the invention contemplates applying catalyst material using a liquid to adhere the catalyst material to a surface of the filter medium without, necessarily, relying on large particle size or another feature to require catalyst particles to become trapped by the filter. The degree to which a wet catalyst particle or a droplet can adhere to a filter medium surface as described can depend on a variety of factors. These can include the relative sizes, shapes, chemistry and surface energy of the surface of the filter medium, the chemistry and surface tension of the liquid, sometimes the size and shape of catalyst particle, as well as others. Sometimes, the capacity of a particle to adhere to a surface can be referred to as an “adhering coefficient” wherein “adhering coefficient” is a value equal to or less than one, that indicates the percentage of contacts of a particle or droplet with the filter medium that result in the particle or droplet adhering to the filter medium. In general, liquids have a higher adhering coefficient than dry solids. Therefore, when a catalyst material is incorporated into or includes a liquid, or when a coating of liquid is applied to a catalyst particle, the catalyst's adhering coefficient in general increases. It can therefore be preferred, in certain embodiments of the invention, to use catalyst materials in liquid droplets to cause the catalyst material to adhere to desired positions on a filter medium, when the catalyst material and liquid are contained in a gas passing through the filter. While dry catalyst material particles may also be useful according to the invention, they are less preferred in certain embodiments of the invention.

One example of a useful combination of liquid and catalyst material is a liquid droplet containing a catalyst particle (optionally and preferably also a dissolved metal containing adhesive component), wherein the relative amount of liquid to catalyst particle is such that the droplet can contact and adhere (i.e., wet) to a structural surface of a filter medium and form an approximately hemispherical drop, droplet, or bump on the filter medium surface with the particle being contained in the drop of liquid wetted to the surface. It is believed that this combination of particle and liquid in a droplet will provide a droplet that, when flowed into a filter by methods described herein, can adhere to a surface of a filter medium and become stationary, without then migrating. Secondarily, and preferably, the liquid can dry, and another component contained in the liquid such as, for example, a dissolved metal containing adhesive component, can further adhere and fix the catalyst material particle to the filter medium in that same position. Notably, the size of the droplet, and not necessarily the size of the catalyst material particle, can have a large affect on how far the catalyst material penetrates into the filter medium and where it remains. The droplet may adhere to any surface it contacts, whether an open surface, a crack or wall of a pore, an intersection of two surfaces, etc., and does not have to be “trapped” by the filter medium the way particles can be filtered by the filter medium during use (i.e., larger particles being trapped in smaller pores). The droplet can preferably be caused to contact and adhere to a surface of the filter medium at a position where, for example, a diesel soot particle would be trapped during filtration of a diesel exhaust stream.

Preferably, according to the invention, the adhering coefficient of a catalyst material or droplet can be selected to achieve a desired effect with a particular type of filter medium. For instance, the chemistry of a liquid (containing or coated on a catalyst material) can be selected to aggressively adhere and bond to a particular filter medium: e.g., in most cases when the surface energy of the droplet surface is much lower than that of the filter medium, the droplet will adhere well. In general, the wetness of the catalyst material particles will also affect the adhering coefficient because a wetter particle will have a higher adhering coefficient. Thus, drying the liquid droplets by, for example, heating the carrier gas, can produce droplets that are smaller and less likely to stick upon initial contact with, and therefore penetrate deeper into, the filter medium. In this manner, the liquid droplets can be positioned in the filter medium at a desired location and at a desired concentration.

A soluble metal species can be included in a catalyst system for any of a variety of reasons, including to function as an active catalyst material when deposited onto the filter medium or as an adhesive to adhere a different active catalyst material to a filter medium, as a NOₓ absorber, or for any other desired or useful function. The soluble metal species, after its carrier liquid contacts a surface of a filter medium and, optionally, upon subsequent treatment such as drying, calcining or firing of the catalyst system, will separate out of the liquid in which it is dissolved to form a solid deposited on a surface of the filter medium. Thus, the soluble metal species can be designed to be an adhesive material that, upon deposition on the filter medium induced by drying and calcining, adheres another material (e.g., an active catalyst particle) to the filter medium. This adhesion of an active catalyst particle occurs through the binding of the soluble metal containing adhesive species to both the catalyst particle and the surface of the filter medium (vide infra). The soluble metal containing adhesive component, when deposited, can secure an active catalyst particle to a filter medium, e.g., a surface of a fiber or other support, so the catalyst is exposed and available for reacting with a particulate or other exhaust matter caught by the filter medium or that otherwise comes into contact with the catalyst. Alternatively, the soluble metal species could deposit into the form of an active catalyst itself. Yet another possible function, the soluble metal species could deposit to form a support upon which a different active catalyst is supported, and the support and catalyst material can be disposed onto the filter medium.

The soluble metal containing species may be one or more of any soluble metal material(s) that will provide a useful function in the catalyst system and filter medium. Such soluble metal materials will include those that function at least as an adhesive component, an active catalyst or as both. They may also function to increase the catalytic activity of (i.e., to support) other potentially catalytic materials, or otherwise. The soluble metal species (e.g., a soluble metal containing adhesive component) can include, for example, a metal complex, metal containing nanoparticles (e.g., metal or metal oxide nanoparticles), and may also include simple metal salts, and combinations of all of the preceding.

Examples of specific types of metal complexes that can be useful as adhesive components according to the present invention include, for example, basic metal salts, soluble metal carboxylates, soluble metal alkoxides (e.g., partially hydrolyzed alkoxides) and combinations thereof. Examples of specific metal complexes that can be useful as an adhesive component according to the present invention include basic metal salts having a formulation wherein at least a part of the counter ion is substituted by hydroxide ion. A general formula for such basic metal salts could be represented by the formula:

M^{X+}(OH)_{x-y}(Z)_{y}(H₂O)ₙ

wherein M is the metal ion, X is the cationic charge on the metal center, Z is an anion, and n is the number of water molecules directly associated with the complex. Important examples include mixtures of zirconyl salts such as zirconyl nitrate and zirconyl acetate in combination with rare earth salts such as cerium nitrate, lanthanum nitrate, and yttrium nitrate and other metal complexes. Examples of specific basic metal salts that can also function as good adhesives according to the present invention include basic metal salts such as basic aluminum salts, basic iron salts, basic zirconium salts and basic titanium salts.

We are aware that nanoparticles are not technically “soluble,” and do not actually dissolve. Even so, for convenience, metal containing nanoparticles have been included in the group defined as “soluble” metal containing adhesive species, because nanoparticles, being extremely small (e.g., on the order of less than about 50 nanometers, or less than about 20 nanometer, in average diameter), can behave like a dissolved metal species even though nanoparticles don't technically dissolve. That is, tiny nanoparticles dispersed in a liquid (i.e., a colloid) can have the effect of adhering larger particles (e.g., active catalyst particles) to a substrate in the same way that a dissolved soluble metal adhesive species can. Examples of metal containing adhesive nanoparticles can include nanoparticles comprised of metal oxides such as, for example, titania, titanates (e.g., barium titanate), ceria, iron oxide, vanadia, zirconia, montmorillonite (and other nano-clays), silica, alumina or the like, and nanoparticles of metals such as, for example, silver, platinum, rhodium, gold, palladium or the like, and combinations of any of the preceding.

Examples of specific simple metal salts that may be useful as an adhesive component according to the present invention include transition metal salts, rare earth metal salts and combinations thereof (e.g., transition and rare earth metal nitrates and chlorides). Simple main group metal salts such as, for example, simple aluminum salts such as aluminum nitrate and aluminum chloride can be used but are less desirable than the basic metal salts or the other metal complexes.

Some of the soluble metal adhesive species can also act as catalytically active material after deposition on the surface of the filter medium and drying, calcining, or firing. Examples of soluble metal adhesive species that form active catalytic materials in this manner can include one or more of precious metal salts, colloidal precious metals, nanoparticulate metal oxy-hydroxides and hydroxides that calcine to form oxide oxidation catalysts, and metal salts and complexes that calcine to form oxidation catalysts.

Examples of precious metal salts can include one or more nitrates and chlorides and other soluble complexes of silver, platinum rhodium, gold, palladium or the like. Colloidal precious metals useful in this regard can include one or more of colloidal silver, platinum, rhodium, gold, palladium or the like.

Nanoparticulate metal oxyhydroxides and hydroxides that form useful oxidation catalysts after calcining can include one or more of nanoparticulate oxyhydroxides and/or hydroxides comprising Al, Fe, Ce, Cu, Mn, Co, Ni, Mg, Ba, Ca, Li, Na, K, La, Y, Zr, Nd, Yb, Zn, Si, W, Mo, V, Ti, Ga and combinations and mixtures of such metal oxyoxyhydroxides and hydroxides.

Metal salts and complexes that calcine to form oxidation catalysts can include one or more of soluble salts and complexes comprising Al, Fe, Ce, Cu, Mn, Co, Ni, Mg, Ba, Ca, Li, Na, K, La, Y, Zr, Nd, Yb, Zn, Si, W, Ta, Nb, Mo, V, Ti, Ga and combinations of these metals.

Certain simple or basic metal salts such as transition metal salts, e.g., basic iron salts and simple copper salts, as well as both basic and simple cerium salts, cerium salt-basic zirconium salt mixtures, rare earth salt-cerium salt mixtures, and basic aluminum salts, can act as both an active oxidation catalyst after being heat processed, and as an adhesive component according to the present invention.

It is believed that a soluble metal containing adhesive component according to the present invention, upon drying, is deposited at points between catalyst material particles and a surface of a filter medium (e.g., a surface of a fiber or other structure that makes up at least part of the filter medium). In preferred embodiments of the filter medium, the filter medium surface can have exposed hydroxy functionalities. The soluble metal containing adhesive components can either be hydroxy functional by nature, in that as precursor materials they comprise a metal hydroxide bond or metal hydroxide moiety, or else they become hydroxy functional at some point in the thermal development of the catalyst (i.e., drying, calcining and/or firing) so as to allow the bonding herein described. Also in preferred embodiments, the adhesive component can be a hydroxy-functional polynuclear cation such as are found in a basic metal salt solution or a polyhydroxy-functional nanoparticle. During drying, calcining or firing, such an adhesive undergoes dehydration. While in contact with catalyst material particles (e.g., hydroxy-functional catalyst material particles) and the filter medium, such dehydration results in the formation of oxo-bonds with both the catalyst material particles and the filter medium. In this fashion, the adhesive chemically bonds the catalyst material to the filter medium, and this catalyst-filter medium bond can be durable and robust. An advantage of adhering catalysts to the filter medium in this manner is that the bonding can occur at temperatures lower than the temperatures that some catalysts begin to become deactivated.

A solid active catalyst can optionally and preferably be used in combination with the carrier liquid and the soluble metal containing adhesive component. For example, a metal oxide or precious metal component, e.g., as a solid particulate, can be included in a catalyst system to provide useful catalytic behavior such as oxidation activity, oxygen storage, or NOₓ catalysis. Examples of such components include precious metals, precious metal oxides, metal oxides, metal and precious metal complexes, and precious metal precursors. Such materials will be generally well-known to the skilled worker in the catalyst and chemical arts, and include materials such as Pt, Pd, Rh, Ru, Ag, etc., precious metal mixtures, and metal oxides such as CeO₂, CeO₂—ZrO₂, V₂O₅, FeO, Fe₂O₃, PdO, CuO, perovskites such as BaTiO3, aluminates such as barium aluminate, calcium aluminate and rare earth aluminates, barium oxide, magnesium oxide as well as others. Often the solid active catalyst material will be composed of a precious metal such as platinum, rhodium or palladium supported on a metal oxide, such as alumina or ceria.

A carrier liquid and one or more of a soluble metal species (e.g., functioning as an adhesive, an active catalyst, a support for another catalyst material or a combination thereof) and optionally a solid active catalyst (e.g., a metal oxide or precious metal), can be used together in a catalyst system in any amounts or combinations of amounts that can be usefully deposited onto a filter medium. Generally speaking, the amount of carrier liquid can be sufficient to allow efficient deposition of active catalyst onto a filter medium, preferably to locate the catalyst advantageously on surfaces of the filter medium where the active catalyst will most likely come in contact with the applicable carbonaceous material(s) or will otherwise be more efficiently used. The amount of soluble metal species can be sufficient to meet its intended function, e.g., as a support material, adhesive, and/or active catalyst. The catalyst (e.g., precious metal, metal oxide, etc.) is in the amount necessary to accomplish the desired result, e.g., selective sites of high density active catalyst.

The amounts of combined ingredients can preferably be sufficient to allow the catalytic filter medium to function to catalyze, e.g., oxidize, specific materials including particulate exhaust matter, with an amount of active catalyst present as either soluble metal species or the precious metal or metal oxide.

Examples of relative amounts of ingredients in a catalyst system according to the present invention can be, for example, in the range from about 40-99% by weight liquid component, about 0.5-25 weight percent soluble metal species, and about 0.5 to 59.5% by weight precious metal or metal oxide catalyst material, especially as solid particulates. In general, the amount of a soluble metal containing adhesive component, when used with ceramic fiber-wound filter media or ceramic fiber-based paper filter media with a precious metal or metal oxide active catalyst particle component, is preferably relatively low, e.g., from about 0.5 to about 10 percent by weight of the solids in the applied mixture, because the addition of relatively larger amounts of soluble metal species such as soluble metal salts can cause embrittlement (i.e., reducing the flexibility) of ceramic fibers by coating too much of the fibers and can reduce the catalytic activity of an active catalyst particulate by blocking access to (i.e., coating too much of) the particulate in the filter medium.

These and other components of similar or different catalyst systems can be used according to the present invention. The chemical or physical nature or chemical identity of the catalyst does not affect the overall concept of depositing the catalyst (whatever its physical state or chemical identity) according to the described techniques, preferably to place the catalyst on the filter medium where the catalyst will be effectively available to contact and catalyze materials to be catalyzed flowing through the filter, and furthermore, to preferably avoid placing catalyst on the filter medium at positions where the catalyst will not contact such materials to be catalyzed.

According to the invention, the filter medium can comprise any three-dimensional structure useful as a filter medium, generally being capable of allowing gas to flow through the medium while exhaust matter such as solid particulates or gaseous pollutants contact, become deposited onto or trapped by surfaces of the filter medium (e.g., fiber surfaces, including ceramic fibers, wool, yarn or paper, or any other inorganic fibers; cells, pores, or other open or closed cellular, honeycomb, foam, mesh, or matrix-like surfaces; intersections or crevices formed between different fibers or surfaces; or other filter media structures described herein), thereby removing that material from the flow of gas. Without limitation, at least three general classes of filter media can be generally identified as useful with the methods of the invention, including: wound fiber filters wherein a fibrous inorganic material such as a natural or synthetic thread or yarn is wound around a support, pattern, or form that allows a gas to flow through the pattern and the wound fibers; pleated, wound ceramic fiber-based paper filters; and monolithic filters, generally in the form of porous types of ceramic filters extruded in the form of a cylinder or brick through which a gas can flow with particulate matter becoming trapped or deposited on inside surfaces of the filter.

With any of these types of filter media, typically but not necessarily, a filter medium can include some type of support structure such as a tube, mesh, wire, honeycomb structure, porous structure, nonwoven, paper, etc., and a catalytic material supported by the support structure. Some filter media are used by incorporating the filter medium into a larger structure such as a filter cartridge, which is designed to direct a flow of gas through the filter medium.

Examples of materials that can be used in a filter medium include: ceramic materials such as extruded ceramics, ceramic foams, and wound ceramic fibers; other types of natural or synthetic fibers wound onto a core into a three-dimensional structure; non-woven materials; paper; wire mesh materials; metallic foams; closed ceramic honeycomb; open flow-type ceramic honeycomb; metal honeycomb; or the other materials.

An example of useful fiber wound filter media include the types of three-dimensional filter media prepared from a fiber wound around a core, for example as described in U.S. Pat. Nos. 5,248,481, 5,248,482, 5,258,164, 5,453,116, 5,409,669, 5,656,048, and 5,830,250, the disclosures of which are incorporated herein by reference in their entirety. These patents generally describe filter cartridges containing a perforated support tube extending between an inlet and an outlet. A filtering “element” is disposed to surround the support tube, and gas is directed to flow through the inlet, through the filter medium, and out the outlet. The filtering element may comprise any of several types of inorganic material. For example, inorganic yarn may be substantially helically wound or cross-wound over the support tube to provide the filtering element.

Examples of other useful filter media include ceramic fiber-based paper filter media like the types generally understood as pleated, wound paper filters including that disclosed in International Patent Application No. PCT/US 02/21333, filed Jul. 3, 2002, claiming priority from Provisional U.S. Patent Application No. 60/303,563, filed Jul. 6, 2001, both incorporated herein by reference in their entirety.

Still other examples of filter media that can be prepared and used according to the invention include filters sometimes referred to generally as “monolithic filters,” as well as the types of filters that generally include a channeled or honeycomb ceramic structure, any of which can advantageously have a catalyst applied thereto according to the present method, preferably depositing the catalyst in position on the filter medium for efficient catalysis during use. See, e.g., U.S. Pat. Nos. 4,652,286 and 5,194,078, the disclosures of which are incorporated herein by reference in their entirety.

Optionally, more than one type of filtering material may be combined to form a filter element or filter medium. For example, in a fiber wound type of filter medium, a non-woven mat may be interposed between a support tube and a fiber wound around the non-woven mat and support tube. The fiber may be, for example, a glass fiber, a refractory ceramic fiber or any other suitable inorganic fiber.

It is contemplated that multiple filter elements or filter media can be used for some applications. For such applications, each filter element or medium can be catalyzed the same or differently, according the present invention. For example, two or more filter media can be aligned in series (i.e., so the exhaust gas has to flow through each filter medium), with each filter medium being the same or different and each filter medium being processed according to the present invention so as to contain a different catalyst, different catalyst concentration or both.

Also, any of the filter media according to the invention can optionally incorporate other components such as a heater (e.g. electric heating elements, microwave-receptive heating elements, etc.) to facilitate burning of exhaust particulate matter and regeneration of the filter medium.

In general, inventive methods include providing catalyst in a gaseous medium, and causing that gaseous medium to flow into a filter medium, for example, by producing a pressure gradient from one side of the filter medium to the other. The gaseous medium flows through the filter medium and catalyst becomes trapped by or otherwise deposits on the filter medium.

Various filter media, catalyst systems and gaseous mediums can be useful according to the present invention, including those describe herein. An amount of catalyst can be introduced into the gas flowing through the filter medium to cause a desirable amount of catalyst to be trapped by or deposited onto the filter medium, over a calculated amount of time, and by allowing a calculated amount (volume) of catalyst material-containing-gas to flow through the filter medium.

For a certain embodiment of the method, a catalyst system comprising catalyst material-containing liquid droplets or wet catalyst material particles can be introduced into a gaseous medium that is flowed through a filter medium so that the catalyst system is deposited onto the filter medium. Catalyst material particles may be made “wet” by introducing dry or drier catalyst material particles into a gaseous medium that has a relatively high humidity level such that moisture in the gaseous medium deposits onto or wets the particles. Catalyst material particles may also be made “wet” before being introduced into a gaseous medium. The catalyst system can be caused to adhere to, and dry after coming into contact with, a surface of the filter medium, so the catalyst material becomes secured to the filter medium in the position proximal to where the liquid droplets or wet particles first came into contact with the filter medium, e.g., exactly at the point of contact or very near thereby. An optional adhesive component can be dissolved or otherwise contained in the liquid to aid in adhering the catalyst material proximal to desired surfaces of the filter medium upon which the liquid droplets or wet particles make contact.

As used herein, “proximal” to the point of contact means that the catalyst material does not migrate after initial contact of the catalyst system to a position that frustrates the concept of the invention, which is to locate catalyst on the filter medium where the catalyst can be used more efficiently than occurs with other methods of applying catalyst, especially to concentrate the amount of catalyst at locations on the filter medium where the catalyst will be contacted by material to be catalyzed, and to locate less or no catalyst at locations that would not allow the catalyst to be contacted by material to be catalyzed. For example, catalyst material may stick to and not bounce off of a first-contacted surface of the filter medium, or not be removed from the first-contacted surface. It can be desirable for the catalyst material to adhere upon contact of the catalyst system to a filter medium surface, but it does not necessarily frustrate the present invention, if the catalyst material, with or without its associated liquid, does not stick until after multiple contacts with the filter medium as long as the catalyst material remains in an area of the filter medium that will be contacted by material to be catalyzed when the filter medium is in use.

Generally, the liquid droplets can include solid or dissolved catalyst materials and can also contain one or more useful additives such as, for example, a wetting agent, adhesive component, etc.. Drying of the liquid droplets or the wet particles can be accomplished by any drying methods, including heating the filter medium. The drying may occur before, during or after, or a combination thereof, depositing the catalyst system on the filter medium. The drying may also or alternatively occur by drying (e.g., heating) the catalyst material, carrier liquid, or gaseous medium prior to depositing the catalyst system onto the filter medium. Heating the filter directly can be accomplished by various useful or known methods, as desired. In addition to or alternatively, liquid droplets and/or the flow of gaseous medium may be heated before contacting the filter medium so that drying begins even before liquid droplets contact the filter medium, allowing very immediate drying of the liquid when contact occurs. Heating the gas flow upstream from the filter medium can also have the advantageous efficient result of allowing the heated gas to also heat the filter medium when the heated gas contacts the filter medium.

Filter media treated with catalyst materials according to the present invention can be calcined and, if necessary, fired in a number of ways. For example, a hot gaseous medium can be passed through the filter medium to heat the filter medium to a temperature that causes the catalyst particles to adhere to the filter medium, that activates the catalyst material, or a combination thereof. In this process, the temperature of the gaseous medium can be raised according to a prescribed program so as to allow removal of all the volatile components without destroying the catalyst bond with the filter medium. In most cases, the temperature of the gaseous medium can be raised more slowly through the ranges of temperatures wherein volatiles are released. The temperature ranges that result in the release of volatiles can be ascertained through thermal gravimetric analysis studies of the catalyst system as is well known in the art.

The filter media treated with catalyst materials, according to the present invention, can also be calcined and, if necessary, fired in more conventional furnaces having either static or forced gas environments. This can be accomplished in box ovens and furnaces or can be done in a continuous fashion on belt furnaces, pusher kilns or tunnel kilns.

Calcination and firing can be carried out in a variety of atmospheres including air, oxygen enriched air, nitrogen, carbon dioxide, argon, or the like. In cases where reduction is desired to activate a catalyst, hydrogen-containing atmospheres such as argon/hydrogen mixtures and hydrogen/nitrogen mixtures can be used. It is also possible to reduce a catalyst material before fully drying the catalyst system on the medium filter by treatment in a reducing atmosphere such as in an atmosphere containing hydrogen, hydrazine or other volatile reducing agents

Immediate or rapid drying of a carrier liquid can result in the advantage of preventing movement of catalyst material throughout a filter medium prior to drying, and therefore provides even greater control of positioning of catalyst material on surfaces of a filter medium, for improved, effective, and efficient use of the catalyst, i.e., efficient contact between catalyst and exhaust matter (e.g., trapped particulate matter) during use of the filter medium. In addition, by controlling the rate of drying of liquid droplets (e.g., aerosol droplets) that carry the catalyst material, or wet catalyst material particles, the nature of the catalyst material supported on the filter medium can be varied from particulate in nature to a film-like coating. For example, if the liquid droplets contain numerous small catalyst material particles in the form of a dispersion and the droplets are allowed to fully spread prior to being immobilized via drying, a more continuous, film-like deposition or coating of the small catalyst material particles can be obtained. On the other hand, the drying can occur during the deposition of the droplets so as to begin to concentrate the catalyst material in the droplets (i.e., to increase the viscosity of or thicken the droplets) prior to the droplets adhering to and spreading on the filter medium so that full spreading of the droplets is not allowed. In the later situation, the small particles can form an agglomerate structure supported on the filter medium. Such an agglomerated structure can be roughly globular in shape or can resemble a mesa in shape.

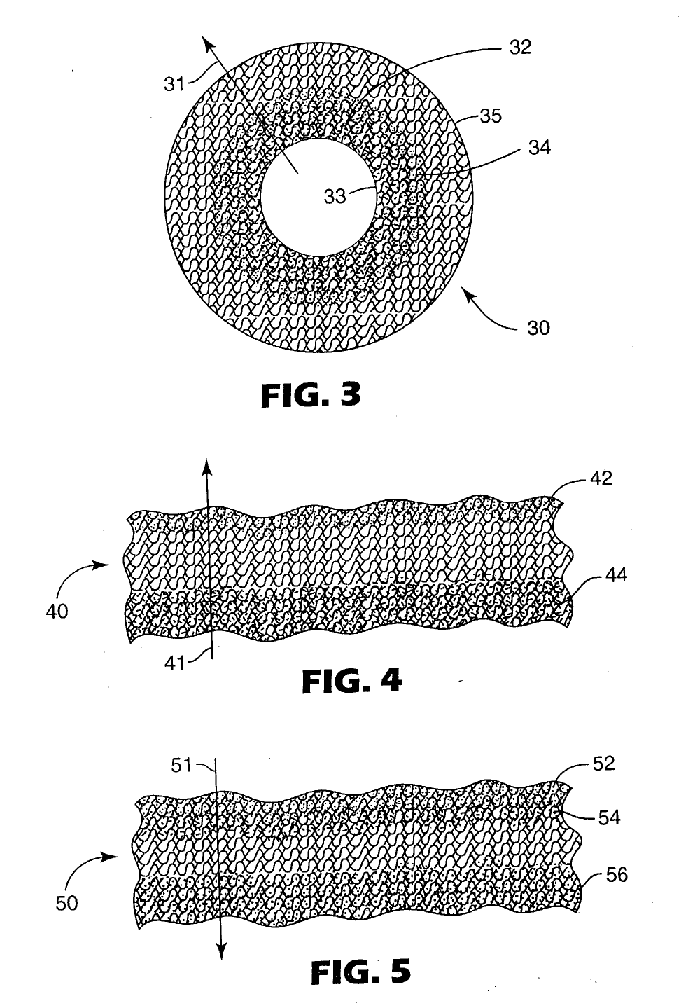

The invention contemplates filters having catalyst located at or within different portions of a filter medium. As shown by FIGS. 3-5, this can mean, for example, that catalyst can be located at different two-dimensional or three-dimensional portions of a cross-sectional thickness range of a filter medium (thickness being with respect to the direction of gas flow through the filter during use), with a substantially similar or uniform concentration of catalyst being present throughout the portion of the filter medium in the direction perpendicular along that thickness range. Such filter media can be prepared according to the invention by simultaneously, separately, or sequentially depositing different types or different concentrations of the same or different catalyst materials onto a filter medium, and by using catalysts materials, optional liquids, and deposition methods that allow placement of the catalyst at different desired positions or regions of the filter medium.

The locations of catalyst can be selected based on the location within the filter medium where a material to be catalyzed (e.g., an exhaust medium) will be located or accumulate in the filter medium, and/or where a particular reaction will take place in the filter medium, during use of the filter medium. For example, a material to be catalyzed may accumulate almost exclusively at an external surface of a filter medium and internally near that surface, especially the intake surface (i.e., where the material to be catalyzed can enter the filter medium). Or, reactions of different materials to be catalyzed (e.g., in a gas exhaust stream) may take place at two or more different locations or regions in the filter medium. For example, differently-sized particles will penetrate different distances into a filter medium. Or, different reactions can occur sometimes sequentially in degrading a component of an exhaust stream, or in an exhaust stream (or other gas) that contains more than one different chemical species to be catalyzed, each of which can be catalyzed by different catalysts. Placing different catalysts at different portions (i.e., depths or thicknesses in the direction of flow) of a filter medium allows different catalysts to react with different materials to be catalyzed (e.g., different sized particles, depending on how far the particles will penetrate into the filter medium), and also allows sequential catalysis of a first such material by a first catalyst, to produce a reaction product, followed by catalysis of the reaction product by a second catalyst located downstream in the filter medium.

As one example, a catalyst designed to promote the oxidation of volatile hydrocarbons could be deposited on one portion of a filter medium, and a different catalyst, such as a catalyst that is more vigorous in the oxidation of carbonaceous soot, could be deposited on another portion of the filter medium. A catalyst useful to decompose a gaseous component, e.g., a volatile hydrocarbon, may be applied to an internal (e.g., downstream) portion of a filter medium, e.g., by being applied prior to application of a second catalyst, and by selecting an application system and method that will cause the volatile hydrocarbon catalyst to become deposited and dried at that internal portion. During use, the gaseous volatile hydrocarbons will penetrate into that interior portion of the filter medium that contains the first catalyst, and will be decomposed there. A second catalyst can be deposited after the first catalyst, e.g., a second catalyst that is effective in decomposing a different chemical species or type of material to be catalyzed, such as a solid as opposed to a gas. The second catalyst system can be selected to not penetrate the filter medium as deeply as the first catalyst, so the second catalyst is located to catalyze materials that also do not penetrate the filter medium as deeply during use, e.g., solid particulates. For example, the second catalyst can be located upstream of the first. With this construction, during use, volatile organic components of an exhaust stream, being in the gaseous state, can penetrate into the first catalyst and become oxidized, while solid particulates such as carbonaceous soot will be trapped toward the upstream surface of the filter medium near the second catalyst (e.g., a carbon oxidation catalyst) to be oxidized there. In this fashion, one catalyst does not block activity of the other catalyst, and use of the interior area of the filter medium can be maximized. In addition, since the catalysts are in proximate association, the thermal energy from the oxidation of one chemical species (e.g., the volatile organic fraction of an exhaust stream) can be used, in whole or in part, to drive the oxidation associated with the second catalyst.

The use of multiple catalysts placed at different portions of a filter medium can also be useful to enable the oxidation of NOₓ compounds to enhance the oxidation of carbonaceous soot (e.g., when NOₓ compounds and carbonaceous soot are found in a single exhaust stream). One such filter medium construction, for example, can involve the initial deposition of a carbonaceous soot catalyzing catalyst in very fine particle form at an internal portion of a filter medium, followed by deposition of a NOₓ oxidation catalyst in the form of coarser, high surface area particles, at an upstream portion of the filter medium. The finer catalyst particles, deposited first, will penetrate relatively more deeply into the filter medium, compared to the later-deposited, relatively larger, coarser catalyst particles. It is desirable for these relatively larger catalyst particles to not be big enough to plug the pores of the filter medium. During use, NOₓ in gaseous form can be oxidized to NO₂ in a first (upstream) portion of the filter medium containing the coarser NOₓ oxidation catalyst. The reaction product, NO₂, of the first reaction, flows deeper into the filter medium and can catalyze a reaction at that deeper portion of the filter medium, e.g., in a reaction to oxidize carbon. Optionally, the NOₓ that is generated in that reaction can be remediated by passage through a second NOₓ reduction catalyst deposited at a further downstream portion of the filter medium, i.e., toward or at the exit side of the filter medium. The NOₓ reduction catalyst can be deposited on the downstream portion of the filter medium using a catalyst deposition technique described herein. For example, a negative pressure can be used to cause a flow of a gaseous medium containing a catalyst system to be deposited from the downstream exit-side surface of the filter medium. Of course other constructions for catalyzing different systems of chemical compounds and reaction products can be prepared in this same fashion or in accordance with other teachings herein and with different types of catalysts.

In these and other embodiments, different catalyst systems can be deposited onto a filter medium from different directions. Specifically, a gaseous medium can be forced to flow in one direction (e.g., upstream) through one side of a filter medium to deposit a catalyst on one side of the filter medium. Either before or after this step, a gaseous medium containing the same or a different catalyst material can be forced to flow in another direction (e.g., downstream) through another side of the filter medium to deposit the same or different catalyst material on another side of the filter medium.

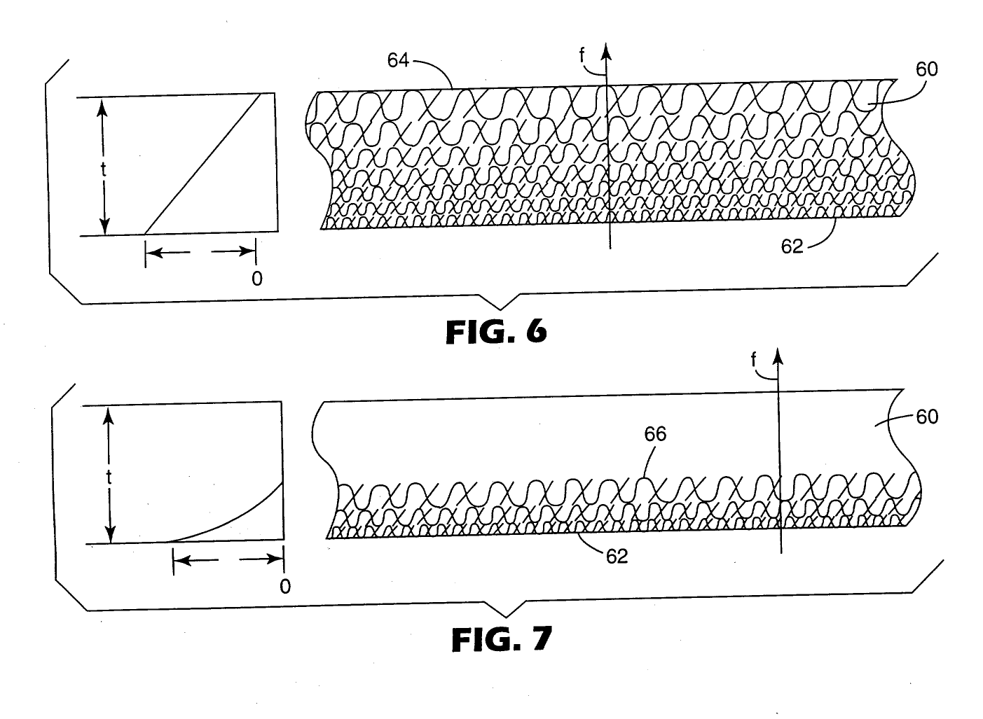

Exemplary embodiments of generic filter media having the same or different catalyst deposited at different portions of the filter medium, prepared according to the invention, are shown generally in FIGS. 3, 4, and 5. The portions of filter media illustrated in FIGS. 3, 4, and 5 that contain deposited catalyst are illustrated as having substantially uniform concentrations of catalyst over those portions; this is not necessary and as shown in FIGS. 6 and 7, catalysts of the invention can be deposited to exhibit a concentration gradient across the thickness of the filter medium.

FIG. 3 shows a cylindrical or annular filter medium 30, which can be made of any type of filter materials or design. Other shapes, including shapes with an oval cross section, an elliptical cross section, a triangular cross section, or a cross section of any other closed geometry may also be used in accordance with the principles of the present invention. Also, filter medium 30 is illustrated as essentially a uniform cylinder with circular surfaces 33 and 35, but it is understood that a filter medium can be of non-uniform cross-section, and irregular surface structure.

Referring still to FIG. 3, the direction of normal flow of exhaust gas during use of filter medium 30 is indicated by arrow 31. A first catalyst material 34 is deposited at an internal or inlet portion of the filter. The terms “portion” and “region,” as used herein refer to a filter medium and are used interchangeably to reference a two or three-dimensional element of a filter medium, generally referring to an element of the filter medium that can be defined by location relative to an external surface of the filter medium. An example is the portion of filter medium 30 that contains catalyst material 34, and which is defined as a cylinder substantially defined by distances from either the inner (inlet) surface 33 of filter medium 30 or distances from outer (outlet) surface 35 of filter medium 30.

Catalyst material 34 is deposited to allow the catalyst material to penetrate a distance into filter medium 30 to be deposited at the internal portion of the filter medium as shown in FIG. 3. This can be due to the catalyst material itself (e.g., its physical state such as dissolved or solid, and if solid, its particle size) or due to the vehicle for placing the catalyst on the filter medium (e.g., being in the form of a liquid droplet). A second catalyst material, 32, is deposited at an upstream portion of the filter medium. The second catalyst material 32 can be the same as or different from catalyst material 34, and can be of a nature or be applied in a form or under conditions that will cause catalyst material 32 not to penetrate into filter medium 30 as deeply as catalyst material 34. Thus, catalyst materials 32 and 34 are deposited onto different portions of filter medium 30 and can independently function to catalyze different reactions, e.g., to catalyze different materials to be catalyzed that are contained in a single gas stream, or to sequentially catalyze reactions of a single material to be catalyzed that is within a gas stream.

FIG. 4 illustrates a filter medium 40 having catalyst material 44 on an upstream portion, and catalyst material 42 on a downstream portion. Catalyst material 44 can be deposited according to the invention using a gaseous medium flowing in direction 41, indicating a direction of gas flow during use of the filter medium. Catalyst material 42 can be deposited according to the invention using a flow in the opposite direction of flow 41. Catalyst materials 42 or 44 can be deposited in any order.

FIG. 5 illustrates a filter medium 50 having catalyst materials 52, 54, and 56, deposited at different portions of the filter medium 50. The catalyst materials 52, 54, and 56 can be deposited on the filter medium by methods of the invention. For example, catalyst material 54 may be deposited at an internal portion of filter medium 50 based on a gas flow in direction 5 1. Catalyst material 52 may be subsequently deposited in a manner to cause catalyst material 52 to penetrate less deeply into filter medium 50, as illustrated, to become deposited on a portion of filter medium 50 that is upstream from catalyst material 54, as illustrated. Catalyst material 56 may be deposited using a gas flow in the direction opposite of flow 51, to deposit catalyst material 56 at a downstream portion of filter medium 50 relative to catalyst materials 52 and 54.

During use, catalyzing filters are placed in a stream of gas containing material to be catalyzed, e.g., exhaust particulate matter such as carbonaceous soot in the case of catalyzing diesel particulate filters. Generally, the exhaust particles are removed from the exhaust gas by coming into contact with the filter medium, becoming trapped or held in nooks, pores, fibers, interstices, etc., in the filter medium, based on the relative size of the exhaust particles compared to the structure of the filter medium. The exhaust particles accumulate where trapped or held by the filter medium, and when the exhaust particles contact well-placed catalyst, the exhaust particles can react to form a degradation product.

The manner in which the particles to be catalyzed (e.g., exhaust particles) are trapped by or accumulate on or in a filter medium during use can define a particle concentration profile across the thickness of the filter medium. That profile refers to the relative concentration of exhaust particles at different locations across the thickness of a filter medium, e.g., as traversed in the same or in the opposite direction of flow of gas through the filter medium during use. (See, e.g., FIGS. 6 and 7.) The exact nature of an exhaust particle concentration profile for any filter medium and exhaust particle system will depend on various factors, including but not limited to: the type of filter medium (e.g., a thin paper, a thick porous or cellular foam, a ceramic, a fiber or wound fiber, a non-woven material, etc.); whether an exhaust particle will reside immediately on a surface of a filter medium or will penetrate into the interior; the types and sizes of passages or paths through the filter medium; the average size and the size distribution and shape of the exhaust particles; and how the exhaust particles interact with structural surfaces of the filter medium, i.e., whether they are moist or wet and therefore adhere to the filter medium upon contact, whether they migrate after adhering, and whether they are dry and therefore adhere only a little or not at all.

FIGS. 6 and 7 illustrate particle concentration gradients across thicknesses of filter media. These can be representative of concentration gradients of catalyst particulate material that are disposed in a filter medium according to a method of the present invention. These figures can also be representative of concentration gradients of particles of matter to be catalyzed (e.g., exhaust particles) that are trapped by a filter medium during use. FIG. 6 shows a segment of filter medium 60 having a thickness (t) in the direction of gas flow (f) and having particles trapped by filter medium 60 as illustrated by a concentration gradient. The particle concentration at surface 62 of filter medium 60 (the inlet surface in this case, based on the direction of flow f) is at its maximum, as shown in the graphical representation at the left. As a particle laden gaseous medium enters intake surface 62, particles are removed from the gaseous medium by being trapped by the filter medium. Fewer particles to be deposited at interior portions of the filter medium and the concentration of trapped particles steadily lessens across the thickness (t) of the filter medium. The lowest concentration occurs at outlet surface 64. (In FIG. 6, the concentration at outlet surface 64 is shown as being greater than zero, but it may also be zero—see FIG. 7.)

FIG. 7 illustrates another possible particle concentration profile. The profile of FIG. 7 is non-linear, and starts at a maximum concentration at surface 62 of filter medium 60 and reduces to essentially zero at a point 66 at the interior of the filter medium 60. Other possible profiles can alternatively occur, depending on factors such as particle type, size, size distributions, adhesiveness, flow properties, filter media properties, etc. For example, some filter mediums will accumulate a majority of trapped particles at the inlet surface of the filter medium with very little particulate matter entering the interior of the filter medium at all. Also, multiple concentration profiles, e.g., of different particles, can be present on a single filter medium.

The invention contemplates catalyzing filter media that contain catalyst concentrated at locations on a filter medium where particulate matter to be catalyzed will contact or become located, trapped or deposited, and accumulate, when the filter medium is being used to filter such particulate matter from a flow of gas. The catalyst can be located on the filter medium to reflect a particle concentration profile of a particle to be catalyzed, on the same filter medium. In this way, catalyst can be placed and concentrated at positions on the filter medium where the catalyst will be contacted by accumulated particulate matter. The catalyst can be present at a lower concentration or can be absent from positions on the filter medium that do not accumulate as much or any particulate matter during use. The expensive catalyst is thereby used very efficiently.

According to methods of the invention, a desired catalyst concentration profile can be achieved by first identifying a particle concentration profile of a particle to be catalyzed on a particular filter medium. As will be understood, the manner in which and the locations at which any specific type of particle or particles will accumulate in a certain type of filter assembly or filter medium during use can be identified by using the filter medium in its intended use (e.g., in a diesel engine exhaust system or other apparatus in which the catalyzing filter is used) or by setting up a duplicate, reproduction, or other model of the filtering system. The used or modeled filter can then be analyzed by viewing and/or measuring particle concentration profiles of particles accumulated at one or multiple locations and thicknesses of the filter medium. The profile can be obtained using a filter medium that does not have catalyst deposited thereon, or if desired, using a filter medium that does have catalyst deposited thereon, e.g., in concentrations that estimate the desired catalyst concentration profile that will be used.

According to the invention, catalyst can be placed onto a filter medium to reflect or mimic concentrations and concentration profiles of particles to be catalyzed by the filter. Once a concentration or concentration profile is identified, e.g., as described above, a system can be designed to place catalyst at locations on the filter medium that are similar to the particle concentration profile. This can be achieved, for example, by observing and selecting factors as identified above when designing a system for applying the catalyst, including, for a particular type of filter medium, controlling whether catalyst material will reside immediately upon first contact with a surface of a filter medium or will first penetrate a desired distance into the interior of the filter medium before coming to rest. Controlling how the catalyst interacts with structural surfaces of the filter medium can be impacted by a number of factors including, for example: whether the catalyst material is in the form of a moist or wet particle or in the form of a particle or solute contained in a liquid droplet (either of these forms may adhere to the filter medium upon contact but the liquid droplet form is more likely to adhere upon first contact); whether the catalyst material will or will not migrate after adhering; or whether the catalyst material is relatively dry and therefore will adhere only a little or not at all. Whether the catalyst material will or will not migrate after adhering can be affected, for example, by the rate of drying, the wetting of the filter medium, and the flow rate of gas into the filter medium. Size, shape, and average size of catalyst material particles can also be controlled and selected and have an affect on the distribution of such particles in a filter medium. Relatively smaller particles can travel further into a filter medium compared to relatively larger particles. On the other hand, the invention contemplates applying catalyst to filter media using catalyst material contained in liquid droplets. The liquid can cause the droplets to adhere to the structure of the filter medium even if the droplets are sufficiently small to not become trapped. Therefore, the size of the catalyst material particles can be a factor. Other factors can also include the size and nature of the liquid droplets with the catalyst material, the interaction between those droplets and the filter medium structure, and whether the wet catalyst material particles or liquid droplets have a sufficient liquid content, or are otherwise sufficiently sticky, to adhere to the filter medium even if they are not large enough to be trapped by the structure of the filter medium. The adhering coefficient of a wet or dry catalyst material particle or liquid droplet can be selected to achieve a desired effect with a particular type of filter medium, e.g., a desired penetration of catalyst material into the filter medium. The adhering coefficient of a wet or dry catalyst material particle or liquid droplet can be selected with respect to its wetting behavior on the filter medium (determined experimentally) and its rate of drying.

Once the concentration profile of the particles to be catalyzed (e.g., exhaust particles) is identified, catalyst can be placed on the filter medium according to a catalyst concentration, for example, that exactly duplicates the exhaust particle concentration profile, that matches the exhaust particle concentration profile but at a uniformly higher concentration (e.g., 1.5, 2, or 5 times the concentration over all locations), or that otherwise uses the results and understanding of the exhaust particle concentration profile and produces a catalyst material concentration profile that includes specific similarities to the exhaust particle concentration profile. For example, a catalyst material concentration profile prepared according to the invention can look like the profiles of FIGS. 6 or 7, or at least have some similarity.

Methods of the invention can be performed using equipment that is commercially available and that will be recognized by those skilled in the arts of gas flow, particle flow, chemistry, or filtration. A useful apparatus may include components such as a gas-flow-generating component for generating a flow of gas, an adapter component for positioning a filter medium in the flow of gas, and a catalyst material introduction component for introducing catalyst material into the flow of gas before the gas contacts the filter medium. Other optional components would include flow directors such as a tunnel, chamber, channel, or other type of guide to cause the gas to flow into, through, and out of the filter medium.

The gas flow-generating component can be any type of equipment that is capable of generating and preferably directing a flow of gas such as air, inert gas, etc. An example of a flow generating component for use with a liquid would include a spray dryer. Optionally, the gas flow-generating component can be capable of directing a flow of gas in either direction through a filter medium. A different way of accomplishing flow in opposite directions through a filter medium would be to turn the filter medium around on the adapter component.

A catalyst material introduction component can be any type of equipment that can place catalyst material, and/or a liquid droplet containing catalyst material, in a stream of flowing gas for introduction into the filter medium, e.g., when installed on the adapter component. The type of the catalyst material introduction component may depend on the type of catalyst, such as whether the catalyst material is a wet or dry solid, or a solid that is suspended, dispersed, or dissolved in a liquid droplet. Exemplary equipment or apparatus useful, for example, for placing a catalyst material-containing liquid into a flow of gas would include a venturi suction devices, electrostatic spray devices, atomization nozzles, spraying nozzles, and the like.

The catalyst material introduction component can be in communication with a single source of catalyst material or with two or more of the same or different sources of catalyst materials. In this way, different catalyst materials can be deposited using the apparatus, either on the same filter medium or different filter mediums. In addition, two or more different catalyst materials can be sequentially deposited onto a filter medium. Further, one or more catalyst materials can be deposited on one side of the filter medium and one or more other catalyst materials can be deposited on the other side of the filter medium using gas flow in opposite directions. Providing the apparatus with two different sources of catalyst material can conveniently and efficiently allow deposition of different catalyst materials onto a single filter medium without transferring the filter medium.

The adapter component can be any mechanical apparatus or mechanism that will allow the filter medium to be positioned and maintained in a flow of carrier gas such that the carrier gas flows in one side (i.e., an “inlet”) of the filter medium, through the filter medium, and out the other side (i.e., an outlet”). The adapter component can be integrated into components including flow directors to guide the flow of gas into, through, and out of the filter medium. The shape, size, and form of the adapter component will depend on the type of filter medium used with the adapter component, i.e., the adapter component should provide an essentially air-tight fit to one side of a filter medium so that gas flows through the filter medium and not around the filter medium. Optionally, the adapter component can be of a form that fits multiple filter media at once. Also optionally, the apparatus may include adapter components to fit different sizes or styles of filter media, or, may fit either side of a single filter media so that gas can be caused to flow in either direction through a single filter medium.

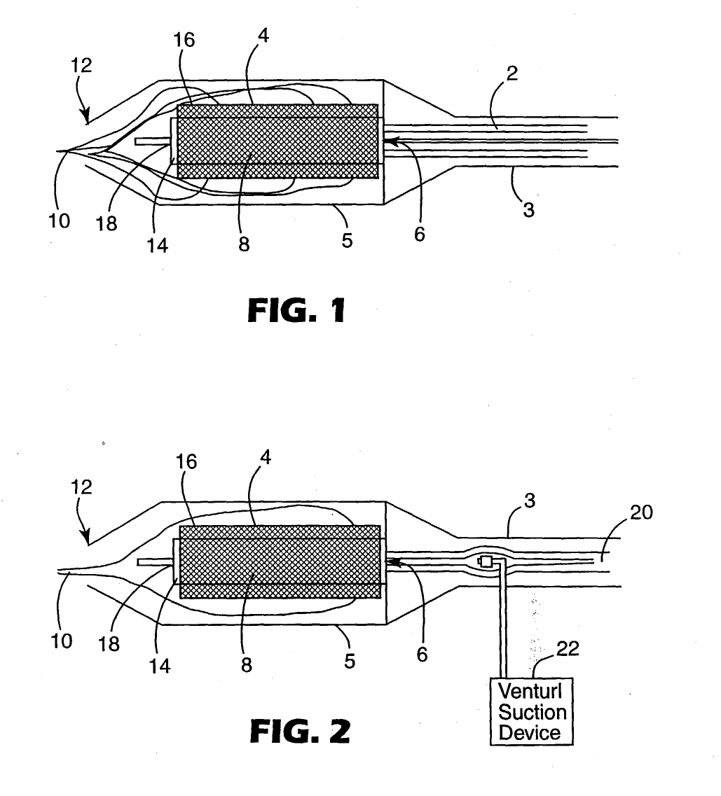

FIG. 1 illustrates generally an exemplary method of depositing catalyst material onto a filter medium according to the invention. Referring to the figure, filter medium 4 is located inside of chamber 5 and set up to allow a gas stream to flow through filter medium 4 and then out exit 12 of chamber 5. Gas stream 2 flows through an inlet nozzle 3, then toward the inlet 6 of filter medium 4. Prior to reaching inlet or nozzle 3 (not shown in the figure) proper amounts of a catalyst system and gaseous medium are prepared into a mixture that becomes gas stream 2. Gas stream 2 flows into inlet 6 of filter medium 4, through filter medium 4, exits filter medium 4, and collects as output stream 10 which ultimately exits output end 12 of chamber 5. Catalyst material contained in gas stream 2 becomes deposited in, trapped in, or otherwise collected by filter medium 4 during the process, preferably as would exhaust particulate matter to be catalyzed that will flow through the filter medium during use. In this way, catalyst becomes deposited in the filter medium at locations where exhaust particulate matter will become deposited or trapped during use, and the catalyst is therefore located in the filter medium where it will be most efficiently used (i.e., contact and react with particulate matter removed from the gas by the filter medium).

The exemplary filter assembly shown in FIG. 1 includes a spun wound filter medium 4 made up of a perforated support cylinder or tube 14, inorganic fiber or yarn 8 wound thereupon, and a closed end 18 which directs gas to flow through the perforated tube 14 and through the wound yarn 8. As stated elsewhere, the method of the invention can be used with any other type of filter, filter cartridge, filter medium, or other filter-type product, by placing the filter, filter medium, cartridge, or filter-type product into a flow of gas such as, for example, gas stream 2 that contains catalyst material.

Also, FIG. 1 does not illustrate that filter medium 4 includes a heating element such as an electrical heating element, to facilitate regeneration of the filter medium. Such a heating element can be included in or used with filter media prepared according to the present invention. In particular, it can be an advantage of the present method that catalyst deposited onto a filter medium becomes deposited at locations very near to a heating element incorporated within or used proximal to the filter medium. Close proximity between the heating element and the catalyst can allow efficient heat transfer between the two during regeneration.

The gas stream 2 of FIG. 1 may be a gas which contains catalyst material in any form. For example, the catalyst material may be in the form fine dry particles of catalyst dispersed in a gaseous medium; or droplets of a carrier liquid such as a mist or aerosol spray, or otherwise, suspended or dispersed in a gaseous medium, where the liquid comprises dissolved or solid catalyst material. Droplets of liquid may be produced by any useful method such as by an aerosol or non-aerosol spray, aspiration, ultrasonically generated fogs and mists, nebulization, atomization, or any other method of producing a liquid droplet that can be introduced into a flow of gaseous medium.

FIG. 2 illustrates an embodiment of the method of the invention that includes introducing catalyst material-containing liquid into a flow of gas, by spraying, injecting, aerating, atomizing, or otherwise introducing, the catalyst material-containing liquid into a gas flow upstream from a filter medium. According to FIG. 2, gas flow 20, which is a gas that either does or does not contain catalyst material, is introduced into inlet 3. Venturi suction device 22 is positioned in gas flow 20 inside of inlet 3, where device 22 introduces catalyst material into flow gas 20 in the form of either particles of catalyst material or dissolved catalyst material contained in a carrier liquid. Here again, catalyst material as part of the gas flow 20 flows into filter medium 4 and becomes trapped by or deposited in filter medium 4, preferably as would exhaust particulate matter that flows into the filter medium during use of the filter.

Where catalyst material is included in a liquid for application to a filter medium, the catalyst material can preferably be applied with one or more adhesive components for securing the catalyst material to the filter medium.

Not shown in either of FIGS. 1 or 2 is a preferred component of the inventive method and apparatus, which is a heating mechanism to heat any one or more of gas flow 2 or 20 of FIGS. 1 or 2, respectively, and filter medium 4. Such a heating mechanism may be based on electrical resistance heating, infrared radiation, microwave, or any other useful or convenient type of energy transferring mechanism. For instance, the heating mechanism may be an electrical resistive coil located at or near inlet 3, or even upstream from inlet 3. Alternatively, infrared radiation or another heating mechanism may directly heat filter medium 4. Or, as another possibility, a heating mechanism may be located at or near venturi suction device 22, or anywhere upstream from the device all the way up to a source of catalyst material(not shown).

Filter media prepared according to the methods described herein may be used or processed, as will be understood by the skilled artisan, as other catalyst material-containing filter media can be used or processed. Often, subsequent to application of a catalyst system to a filter medium, especially if a liquid is used in the application, the catalyst material can be heat-treated (i.e., dried, calcined or fired) to secure the catalyst material to the filter medium. Rapid drying of a catalyst material-containing liquid during application of the catalyst system to a filter medium can be accomplished as described above, e.g., by heating the gas flow upstream of or through a filter medium or by heating the filter medium during application of the catalyst system. Or, heating can be accomplished in a separate later step, by any known method.

The present methods of introducing a catalyst into a filter medium may be used to apply a catalyst to a never used filter medium or to re-apply a catalyst to a previously catalyzed filter medium that was used and/or cleaned of, e.g., carbonaceous matter (e.g., by regeneration) and/or of ash (e.g., by washing or blowing out the filter medium), where the use and/or the cleaning requires additional catalyst to be applied to the filter medium. It is also contemplated that the present methods of introducing a catalyst into a filter medium can be used with standard catalyst application methods. For example, a standard method can be used to apply a less expensive catalyst or a catalyst that is usually desired on all or most of the filter medium (e.g., NOₓ absorbers), and a present method can be used to selectively apply more expensive catalyst. A present method can be used before or after the standard method is used.

Catalyst material-containing filter media prepared by a method of the present invention may be subsequently incorporated into a larger filter product, filter cartridge product or any other suitable filter assembly. Such filter assemblies may be used in accordance with known filtering methods, such as by inserting the filter assembly into a gas stream that contains contaminant particles to filter out the particles, and optionally including a step of regenerating the filter medium. As only one exemplary application, such filter assemblies can be useful for filtering exhaust particulate matter from diesel exhaust streams. Other applications will be apparent to those of ordinary skill, and might include applications such as pollution remediation and other hot gas treatments.

### EXAMPLES

Two identical catalyst material mixtures were synthesized according to the following steps:

1) a ceria-zirconia-yttria support was prepared by hydrolyzing the requisite metal salt mixture (vide infra) in an ammonium hydroxide solution followed by calcination of the resulting metal oxy-hydroxide;

2) palladium chloride was supported on the calcined ceria-zirconia-yttria particles by the well-known incipient wetness technique followed by calcination;

3) palladium oxide on ceria-zirconia-yttria particles were milled in the presence of the adhesion promoting complexes zirconyl acetate and cerium nitrate to generate a catalyst material mixture.

One sample of the catalyst material mixture was then supported on a wound fiber filter medium by immersing the filter medium in the catalyst material mixture, followed by drying and calcining to fix the catalyst on the filter medium. A second sample of the catalyst material mixture was divided into two portions wherein one portion was 60% of the original amount and one portion was 40% of the original amount. The 60% portion was supported on a wound fiber filter medium using the inventive process where in the catalyst material mixture was sprayed into and through the wound fiber filter medium using hot air as a gaseous medium and a spray drying apparatus to atomize the catalyst material mixture. Despite the fact that the catalyst amount had been reduced by 40%, the filter medium was found to regenerate at a lower energy than the filter medium that had been treated with the full amount of catalyst in the traditional fashion. Thus, the present invention can enable substantial savings in reduced catalyst usage and in reduced energy consumption for filter regeneration.

### Comparative Example 1

Comparative Example 1 involved the use of a non-catalyzed heater integrated fiber wound filter (3M Company: product designation XW3H-078). This is used for comparative purposes as a non-catalyzed control. Comparative Example 2 involved the same filter type as comparative Example 1, but was catalyzed using the traditional method.

### Preparation of the Catalyst Material Mixtures for Use in Comparative Example 2 and Example 1

Preparation of the Ceria-Zirconia-Yttria: A zirconyl nitrate solution was prepared by adding 500.0 g zirconium basic carbonate paste (40% ZrO₂ equivalence; Magnesium Electron, Inc., Flemington, N.J.) in small portions to a stirred mixture of 204.0 mls concentrated nitric acid in 1800 g of deionized water. After the zirconium basic carbonate was fully dissolved and the evolution of gas had ceased, the mixture was concentrated to 20.0% zirconia by weight via roto-evaporation (bath temperature=35° C., aspirator reduced pressure). The zirconyl nitrate solution was filtered prior to use. An aqueous metal salt solution mixture was prepared by combining 162.33 g of this zirconyl nitrate solution (20% by weight ZrO₂) with 162.33 g of a cerium (III) nitrate solution (20% by weight ceria solution), and 1000 g water. The final metal salt mixture was prepared by dissolving 16.23 g of yttrium nitrate hydrate (29.5% Y₂O₃) crystals in the zirconyl nitrate-cerium nitrate solution. The final mole ratio of ZrO₂:CeO₂:Y₂O₃=1.00:0.716:0.08.

An ammonium hydroxide solution was prepared by mixing 60.0 mls of concentrated ammonium hydroxide with 1000. g of water. While agitating this solution at high speed using a Ross ME100 mixer (Charles Ross and Son Company, Hauppauge, N.Y.), half of the metal salt mixture was added dropwise. After this addition, an additional 50.4 mls of concentrated ammonium hydroxide was added to the ammonium hydroxide solution. The remainder of the metal salt solution was then added dropwise with rapid stirring to the stirred ammonium hydroxide solution. After the addition, the solids were allowed to settle and the material was washed by decantation with about 4 liters of deionized water. The solid was stirred in 1000 mls of deionized water and the final washed solid was separated by centrifugation (4000 rpm, 15 minutes). The solid was dried at 100° C., crushed in a mortar and pestle, and calcined according to the schedule: 100° C. to 500° C. in three hours, hold at 500° C. for 0.5 hour, heat to 800° C. in 1 hour 800° C. for 1 hour, then cool with the furnace. The material was pulverized in a mortar and pestle to yield a fine yellow powder. The powder was slurried with 600 mls deionized water and was placed in a 32 ounce wide mouth poly bottle containing 1900 g of zirconia mill media (Union Processes, Incorporated, Akron, Ohio). The mill media consisted of 50% by weight about 6.6 mm cylinders and 50% by weight about 12.3 mm cylinders). The lid was secured on the poly bottle and the mixture was vibro-milled for 48 hours using a Sweco M18-5 mill (Sweco Incorporated, Florence, Ky.). After milling, the contents were separated from the mill media and the solids were recovered by drying the mixture at 80° C. The solid product was ground using a mortar and pestle in to a free flowing yellow solid.

Palladium chloride was supported on the ceria-zirconia-yttria powder in the following fashion. A palladium chloride solution was prepared by dissolving 2.67 g of palladium chloride in 80.0 g of deionized water along with 3 mls of concentrated nitric acid and 2 mls of concentrated hydrochloric acid. The mixture was sonicated for one minute using a Branson Cell Disruptor 350 (Smith-Kline Company, Danbury, Conn.) fitted with a high-energy sonic horn. The palladium chloride solution was added to 32.0 g of the ceria-zirconia-yttria powder in a beaker along with a magnetic stir bar. The solution was stirred and heated to about 80° C. while blowing nitrogen gently over the surface of the mixture to promote evaporation. After the mixture was concentrated to a paste, the mixture was heated and turned by hand using a spatula to provide a dried mixture. The dried mixture was calcined according to the schedule: room temperature to 450° C. in one hour, hold at 450° C. for 30 minutes, then cool with the furnace.

The final catalyst material dispersion (i.e., catalyst system) was prepared by charging a 32 ounce wide-mouth poly bottle with 1900 g of zirconia mill media (as previously described), the calcined, palladium treated ceria-zirconia-yttria, 400.0 g deionized water, 7.37 g of cerium nitrate solution, and 5.94 g of zirconyl acetate solution (22% by weight zirconia, MEI Incorporated, Flemington, N.J.) and milling the mixture for 3 hours and 10 minutes using the Sweco M18-5 mill. The dispersion was separated from the mill media by filtration and immediately applied to the wound fiber filter.

For Comparative Example 2, the catalyst material dispersion was applied to the filter medium by pouring the mixture into the filter from the inside out. All of the dispersion was poured into the filter until all of the dispersion was contained in the filter medium. The saturated filter was then dried in a forced air furnace at 100° C. and then calcined according to the schedule: room temperature to 110° C. in 10 minutes, 110° C. to 500° C. in 1.5 hours, hold at 500° C. for 30 minutes, and then cool to room temperature with the furnace.

### Example 1

In Example 1, the same filter type was used as used in Comparative Examples 1 and 2, but it was catalyzed using a method of the instant invention. The catalyst material dispersion for Example 1 was prepared identically to that of Comparative Example 1. Sixty percent of the final mass of the catalyst material dispersion was supported on a wound fiber filter in the following manner. A Büchi B191 Mini Spray Drier was set up so as to allow a hot gas spray carrying an aerosol of the catalyst material dispersion to be passed through the Example 1 filter. To accomplish this, a cone-shaped Pyrex™ glass coupler was prepared having an entrance ID of 104.4 mm and an exit ID of 63.7 mm and an overall height of 16.5 cm. The cone was attached to the spray dryer with the entrance orifice attached at the point where the atomizer generates the spray droplets. The filter was then attached to the coupler having the entrance orifice of the filter snuggly attached to the exit orifice of the coupler to allow the hot carrier gas to be passed through the filter and, thereby, the generated droplets to be carried into the filter medium. The entrance temperature was adjusted to 210° C. and the catalyst material dispersion was sprayed into the filter at a rate of about 6-7 ml/minute. Essentially all of the catalyst material dispersion sprayed into the filter was captured in the filter medium. After the catalyst material dispersion was sprayed into the filter using the spray drying apparatus, the filter was removed from the spray drier, and dried at 100° C. overnight. The filter was then calcined exactly as in Comparative Example 1.

Evaluation:

Comparative Example 1, Comparative Example 2 and Example 1 were evaluated using a 3.4 L IDI diesel engine (Cummins 6A) run at 2400 rpm-1800 psi (7.1-7.6 m³/min. at 360-400° C.). Particulate exhaust matter (carbonaceous soot) was loaded into the filter until the filter pressure drop reached 40 kPa. At that point, electrical power was supplied into the heater integrated in the filter in order to initiate regeneration. At once the engine condition was turned to idling (800 rpm-no load: 1.1 Nm³/min.), the power was supplied for 10 minutes. When the power was turned off, the engine speed was increased to 2400 rpm-1800 psi again and the pressure drop after the regeneration was measured. In this way, needed power for 90% regeneration (pressure drop difference between regeneration start and end is 90% of pressure drop at the regeneration start) was determined.

Result:

Table 1 shows the needed power for 90% regeneration of the two kinds of catalyzed filter and the non-catalyzed filter.

TABLE 1
Needed Power for 90% Regeneration

| | Comparative | | |
|---|---|---|---|
| | Example 1 | Comparative | |
| | No catalyst | Example 2 | Example 1 |
| Accumulated | 9.0 g | 11.5 g | 11.0 g |
| particulate | | | |
| exhaust | | | |
| material at start | | | |
| Needed Power | 4.8 kW | 1.7 kW | 1.0 kW |

The result shows that the Example 1 filter, catalyzed with a method according to the present invention, regenerated at a lower power level than (i.e., at about 59% of the power needed for) the Comparative Example 2 filter that was catalyzed with a traditional method, even though the Example 1 filter medium contained only 60% of the amount of catalyst in the Comparative Example 2 filter medium and the same catalyst material was used in both examples. This data supports the position that the instant invention allows for a more efficient use of catalyst compared to traditional catalyst application methods. With the present invention, less or no catalyst is wasted by being provided in portions of the filter medium that do not participate in the catalyzation (e.g., oxidation) of the exhaust matter (e.g., soot). Thus, as this example demonstrates, the present method enables a greater efficiency in regeneration while using lower levels of catalyst (e.g., precious metal). It is believed that this regeneration efficiency is achieved because the present invention allows a greater density of active catalyst to be placed at sites in the filter medium where the catalyzation of exhaust matter (e.g., oxidation of soot) is required for regeneration and removal of the exhaust matter (e.g., soot).

1. A method of manufacturing a catalyzing filter medium suitable for use in an engine exhaust, the method comprising:
providing a filter medium suitable for use in an engine exhaust;
providing a catalyst system comprising a catalyst material and a liquid;
dispersing the catalyst system in a gaseous medium so as to form a gaseous catalyst dispersion; and
flowing the gaseous catalyst dispersion into the filter medium such that the gaseous medium flows through the filter medium and at least some of the catalyst material and liquid deposits on surfaces of the filter medium.

2. The method of claim 1, wherein the gaseous catalyst dispersion comprises catalyst material in the form of solid particles coated with liquid.

3. The method of claim 1, wherein the gaseous catalyst dispersion comprises droplets of the liquid with catalyst material located in the droplets.

4. The method of claim 1, wherein during said flowing, the catalyst system comprises droplets of the liquid with the catalyst material contained in the droplets.

5. The method of claim 4, wherein the catalyst system includes a soluble metal containing adhesive component for bonding the catalyst material to at least one surface of the filter medium.

6. The method of claim 5, wherein the soluble metal containing adhesive component comprises a metal complex, a simple metal salt, a metal containing nanoparticle or a combination thereof.

7. The method of claim 6, wherein the metal complex comprises a basic metal salt, a metal carboxylate, a metal alkoxide or a combination thereof.

8. The method of claim 7, wherein the basic metal salt has a formulation wherein at least a part of the counter ion is substituted by hydroxide ion.

9. The method of claim 7, wherein the basic metal salt is represented by the formula:
M^{X+}(OH)_{x-y}(Z)_{y}(H₂O)ₙ
wherein M is the metal ion, X is the cationic charge on the metal center, Z is an anion, and n is the number of water molecules directly associated with the complex.

10. The method of claim 6, wherein the simple metal salt comprises a transition metal salt, a rare earth metal salt, a main group metal salt, or a combination thereof.

11. The method of claim 6, wherein the metal containing nanoparticles comprise a metal oxide, a metal or a combination thereof.

12. The method of claim 5, wherein the soluble metal containing adhesive component functions as a catalyst material that is adherent to the filter medium.

13. The method of claim 1 further comprising:
heating the filter medium, the gaseous medium, the catalyst material, the liquid or a combination thereof before, during or after said flowing.

14. The method of claim 13, wherein said heating is sufficient to cause a reaction that results in catalyst material, deposited as a result of said flowing, permanently adhering to at least some of the surfaces of the filter medium.

15. The method of claim 1 further comprising:
drying the liquid before, during or after being deposited onto surfaces of the filter medium such that the mobility of the catalyst material, after being deposited onto surfaces of the filter medium, is reduced.

16. The method of claim 1, wherein after said flowing, the filter medium has deposited catalyst material concentrated at locations in the filter medium where material to be catalyzed that flows into the filter medium will contact the filter medium, and the filter medium has at least a lower concentration of deposited catalyst material at locations in the filter medium where the material to be catalyzed that flows into the filter medium will not contact the filter medium.

17. The method of claim 1, wherein the provided filter medium will filter solid particles to be catalyzed according to a particle concentration profile and, after said flowing, the catalyst material is deposited on surfaces of the filter medium according to a catalyst concentration profile that reflects the particle concentration profile.

18. The method of claim 1, wherein the filter medium being provided comprises an inlet into the filter medium and an outlet out of the filter medium, said method further comprises:
providing another catalyst system comprising another catalyst material and another liquid;
dispersing the other catalyst system in another gaseous medium to form another gaseous catalyst dispersion; and
said flowing further comprises:
flowing the gaseous catalyst dispersion into the inlet of the filter medium such that the gaseous medium flows through the filter medium and the catalyst material deposits on surfaces of the filter medium according to a first concentration profile, where the catalyst material is deposited at a higher concentration at the inlet and a lower concentration at the outlet, and
flowing the other gaseous catalyst dispersion into the outlet of the filter medium such that the other gaseous medium flows through the filter medium and the other catalyst material deposits on surfaces of the filter medium according to a second concentration profile, where the other catalyst material is deposited at a higher concentration at the outlet and a lower concentration at the inlet.

19. The filter medium manufactured according to the method of claim 1.

20. The filter medium of claim 19 in combination with additional structure so as to form a filter.

21. The filter medium of claim 19 in combination with additional structure so as to form an engine exhaust filter.

22. The filter medium of claim 19 in combination with an engine exhaust system that includes said filter medium.

23. The filter medium of claim 19 in combination with an engine having an engine exhaust system that includes said filter medium.

24. A catalyzing filter medium suitable for use in an engine exhaust, said filter medium comprising:
a porous body suitable for use in an engine exhaust;
catalyst material concentrated at locations in said porous body where material to be catalyzed flowing into said filter medium will contact said catalyst material,
wherein said filter medium comprises a lower concentration of said catalyst material at locations in said filter medium where the material to be catalyzed flowing into said filter medium will not contact said porous body.

25. The filter medium of claim 24, wherein said filter medium will filter solid particles to be catalyzed according to a particle concentration profile and said catalyst material is located on surfaces of said porous body according to a catalyst concentration profile that reflects the particle concentration profile.

26. The filter medium of claim 24, wherein said porous body has an inlet and an outlet, said catalyst material comprises a first catalyst material and a second catalyst material that are different, said first catalyst material is located in said porous body according to a first catalyst concentration profile where said first catalyst material is at a higher concentration at said inlet and at a lower concentration at said outlet, and said second catalyst material is located in said porous body according to a second catalyst concentration profile where the second catalyst material is at a higher concentration at said outlet and a lower concentration at said inlet.

27. The filter medium of claim 24, wherein said catalyst material comprises a first catalyst material and a second catalyst material that are different, said first catalyst material being concentrated at locations in said porous body where a first material to be catalyzed, flowing into said filter medium, will contact said first catalyst material, said second catalyst material being concentrated at locations in said porous body where a second material to be catalyzed, flowing into said filter medium, will contact said second catalyst material, said filter medium comprises a lower concentration of said first catalyst material at locations in said filter medium where the first material to be catalyzed, flowing into said filter medium, will not contact said porous body, and said filter medium comprises a lower concentration of said second catalyst material at locations in said filter medium where the second material to be catalyzed, flowing into said filter medium, will not contact said porous body.

28. The filter medium of claim 27, wherein said first catalyst material is effective to catalyze reaction of a first exhaust matter to produce a reaction product, and said second catalyst material is effective to catalyze reaction of the reaction product to still another reaction product.

29. The filter medium of claim 28, wherein said first catalyst material catalyzes a particulate material and said second catalyst material catalyzes a gaseous material.

30. A catalyzing filter medium suitable for use in an engine exhaust, said filter medium having a thickness and comprising a catalyst material for catalyzing a reaction of exhaust particles flowing into said filter medium, said filter medium having a concentration profile of said catalyst material across said thickness reflecting a concentration profile of exhaust particles that occurs when the exhaust particles become deposited in said filter medium during use of said filter medium in an engine exhaust.

31. A catalyzing filter medium suitable for use in an engine exhaust, said filter medium comprising an inlet surface, an interior surface and an outlet surface, said filter medium having a concentration of a catalyst material at said inlet surface, a relatively lower concentration of said catalyst material at said interior surface, and a lowest concentration of said catalyst material at said outlet surface.

32. The filter medium of claim 31, wherein an initial concentration of said catalyst material is present at said inlet surface, the concentration of said catalyst material in said filter medium continuously reduces from the initial concentration at said inlet surface to a zero concentration at said interior surface, and the concentration of said catalyst material at said outlet surface is zero.
